(19) United States
(12) Patent Application Publication
(10) Pub. No.: US 2026/0175637 A1
(43) Pub. Date: Jun. 25, 2026

(54) LOAD DISTRIBUTION IN TRUCKING TRANSPORTATION AND CONTROL OF PARAMETERS OF CARGO INSIDE TRAILERS

(71) Applicant: Mouse Scale LLC, North Royalton, OH (US)

(72) Inventors: Andriy HAPYUK, North Royalton, OH (US); Yaroslav HAPYUK, North Royalton, OH (US)

(21) Appl. No.: 19/541,290

(22) Filed: Feb. 16, 2026

Related U.S. Application Data
(63) Continuation-in-part of application No. PCT/US2024/042304, filed on Aug. 14, 2024.
(60) Provisional application No. 63/519,442, filed on Aug. 14, 2023.
(60) Provisional application No. 63/767,430, filed on Mar. 5, 2025.
(60) Provisional application No. 63/902,646, filed on Oct. 21, 2025.

(51) Int. Cl. B60G 17/018; B60G 11/27; G01G 19/10

(52) U.S. Cl. CPC B60G 17/0182; B60G 11/27; G01G 19/10; B60G 2400/61; B60G 2400/63

(57) ABSTRACT

Methods and systems for generating axle weight and load distribution value estimates that include receiving a pressure associated with an air-ride suspension of a drive axle of a vehicle or a trailer axle of the vehicle, receiving vehicle information associated with a characteristic of the vehicle, receiving load information associated with a load of the vehicle, and calculating a weight value estimate including at least one of a gross weight of the vehicle, a single-axle weight for the vehicle, or a tandem-axle weight for the vehicle or a load distribution value estimate based on the pressure, the vehicle information, and the load information. The methods and systems can be used to determine and control the weight of cargo inside trailer, the location of its center of gravity and make determinations regarding additional weight capacity of the truck without moving the fifth wheel.

### CROSS-REFERENCE TO RELATED APPLICATIONS

This application is a continuation-in-part of International Patent Application No. PCT/US2024/042304, filed Aug. 14, 2024, and claims priority to U.S. Provisional Pat. App. Ser. No. 63/519,442, filed on Aug. 14, 2023, U.S. Provisional Pat. App. Ser. No. 63/767,430, filed Mar. 5, 2025, and U.S. Provisional Pat. App. Ser. No. 63/902,646, filed Oct. 21, 2025.

### BACKGROUND OF INVENTION

In the United States and in other countries, there are regulations that limit the amount of weight that can be transported by a truck and/or trailer over roadways. The limits are typically measured as a function of the weight born by each axle. Some trucks and most trailers do not have onboard equipment for accurately determining and managing axle weight. Thus, it is customary in the United States and in other countries for truck drivers to travel to certified scales to measure the axle weight of typical loads. This takes time, and there is a fee associated with the axle weight measurement service. Further, measurements of this type must be done, on average, about once per week.

Due in part, to the risk of fines for hauling loads in excess of the axle weight limits and, in part, to the lack of accurate real-time axle weight information due to time and cost, trucks and trailers frequently haul less freight than the maximum lawful capacity. This adversely affects profit margins for shippers, drivers, and carriers. It also results in an unnecessary waste of fuel to make additional trips. It is estimated that at least 700,000 tons of diesel fuel are wasted each year in the United States for trips to certified scales to verify this information.

### BRIEF SUMMARY OF THE INVENTION

According to one aspect, a system for generating axle weight and load distribution value estimates may include a memory and a processor. The memory may store one or more instructions and the processor may execute one or more of the instructions stored on the memory to perform one or more acts, actions, and/or steps. For example, the processor may receive load information, pressure or weight associated with an air-ride suspension of a drive axle of a vehicle or a trailer axle of the vehicle, receive vehicle information associated with a characteristic of the vehicle, calculate load information associated with a load of the vehicle, and calculate a weight value estimate including at least one of a gross weight of the vehicle (e.g., with and/or without the trailer), a single-axle weight for the vehicle, or a tandem-axle weight for the vehicle based on the pressure, the vehicle information, and the load information. According to one aspect, a method for generating axle weight and load distribution value estimates may include receiving load information, pressure or weight associated with an air-ride suspension of a drive axle of a vehicle or a trailer axle of the vehicle, receiving vehicle information associated with a characteristic of the vehicle, calculating load information associated with a load of the vehicle, and calculating a weight value estimate including at least one of a gross weight of the vehicle, a single-axle weight for the vehicle, or a tandem-axle weight for the vehicle based on the pressure, the vehicle information, and the load information.

According to one aspect, a system for generating axle weight and load distribution value estimates may include a memory and a processor. The memory may store one or more instructions and the processor may execute one or more of the instructions stored on the memory to perform one or more acts, actions, and/or steps. For example, the processor may receive a pressure value associated with an air-ride suspension of a drive axle of a vehicle or a trailer axle of the vehicle, receive vehicle information associated with a characteristic of the vehicle, calculate load information associated with a load of the vehicle, and generate a suggested action pertaining to the load or a vehicle configuration based on the pressure value, the vehicle information, and the load information.

The foregoing and other features of the invention are hereinafter more fully described below, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is an exemplary component diagram of a system for generating axle weight and load distribution value estimates, according to one aspect.

FIG. 2 is an exemplary flow diagram of a method for generating axle weight and load distribution value estimates, according to one aspect.

FIG. 3 is an exemplary schematic side view of a vehicle and a semi-trailer on which the system and method for generating axle weight and load distribution value estimates may be implemented, according to one aspect.

FIG. 4 is an exemplary schematic bottom plan view of the vehicle and the semi-trailer of FIG. 3, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION OF THE INVENTION

The present invention advantageously unites seven important variable parameters and constants of trucks and trailers. Most existing scales control no more than three variable parameters and are thus only able to provide up to four simple results about the weight. With the use of the present invention and the electronic devices disclosed herein, it is possible to obtain twenty-five results regarding weight of truck, trailer and cargo. This application explains how the information is acquired and the calculations that are made to obtain this information, and provides a preferred implementation.

U.S. Pat. No. 8,424,892 B2 is hereby incorporated by reference in its entirety. U.S. Pat. No. 8,424,892 B2 discloses and teaches the use of air fittings such as Schrader valves in the air-ride suspension system of a vehicle. Schrader valves are usually covered with a cap, which must be removed before a hand-held pressure gauge is used to measure the pressure at the valve. The installation may include use of valves in the air-ride suspension of a vehicle, which do not require removal of a cap in order to permit measurement of air pressures using a hand-held gauge. Suitable valves include, but are not limited to, double seal valve caps under the DS-1 designation. Use of a valve that permits a pressure measurement to be rapidly made without removal of a cap provides the benefit of quick access while still protecting the valve from snow, ice, and salt.

This disclosure provides improvements in the technical field of determining axle weight and load distribution for vehicles, such as a tractor towing a semi-trailer, for example. Information associated with a pressure associated with an air-ride suspension of an axle of a vehicle, vehicle information, and load information may be received by a software application operating on a smartphone, tablet, electronic plug-in device, GPS navigator, on-board truck computer or computer (e.g., the system for generating axle weight and load distribution value estimates) and processed to provide approximate axle weight information to drivers or operators of the vehicle when needed. This enables drivers to pick up additional loads, which improves profit margins and saves fuel and energy. It is no longer necessary for drivers to drive a vehicle or pull a trailer that has available space and is below the maximum axle weight limits. Additionally, the disclosure reduces the need of a driver to visit a certified scale to determine whether the weight on the axles of a loaded trailer permits or prohibits picking up additional loads without exceeding legal limits. Furthermore, the disclosure provides drivers with additional information including, but not limited to, explanations, media, video lessons, or text, which shows the driver exactly how to manage axle weight for a particular load and achieve maximum lawful capacity.

There are many factors that affect the weight on an axle (e.g., the amount of fuel in the tanks, the location of the fuel tanks relative to the axles, the amount and location of diesel emission fluid (DEF), the weight of a fifth wheel, if present, and the weight of the front portion of the trailer that is supported by the fifth wheel of the vehicle, the location of the fifth wheel and trailer tandems and the distance they can be adjusted, the weight of the driver and any passengers, the weight and location of additional equipment, and the weight and center of gravity of the load(s), etc.). These factors are unique to each vehicle (e.g., there is no standard that applies to every vehicle).

In accordance with the disclosure, after performing a calibration, the software application operating on the smartphone, tablet, or computer, may determine the weight of various physical objects and their respective position/location on the particular vehicle and/or trailer with reasonably sufficient accuracy. The software application may calculate coefficients of weight distribution for such physical objects and locations. Furthermore, measurements of distances between physical objects on or associated with the vehicle or trailer allow for more useful information for drivers and carriers.

It may be more cost-effective to measure the pressure in an air-ride suspension and calculate weight, as opposed to spending the money to install an onboard scale on each vehicle and trailer or as opposed to spending the money to travel to a scale and pay for a weight determination. The use of the system for generating axle weight and load distribution value estimates is advantageous because it allows a driver to make far fewer periodic controlled weightings, but instead may update the parameters associated with the air-ride suspension for the system to improve accuracy.

Further, a smartphone, tablet, electronic log-in device (“ELD”), global positioning system (“GPS”) navigator, on-board truck computer and/or computer may store and share information via an internet connection regarding various vehicle parameters and trailer parameters. This allows for machine learning, where a wide range of users contribute to an improving accuracy in parameters used to make the calculations. It will be appreciated that it may be desired to perform controlled weightings and pressure measurements (e.g., recalibration) after repair work is conducted on the air-ride suspension to correct/adjust the parameters of linear dependence between pressure and weight.

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “drive” or “disk”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any motor vehicle that is capable of towing a trailer.

Unless otherwise noted, a line of vehicle movement in a straight direction is an imaginary line on the ground where the vehicle is located, which is perpendicular to the drive axles of the vehicle and is parallel to the direction of movement of the vehicle when driven in a straight line on the wheels of the vehicle. A location of an object on the vehicle is a perpendicular projection of the center of gravity of the object or other described point relative to the line of vehicle movement in a straight up-down direction (e.g., the z-axis). A distance between the two locations on the vehicle is a linear distance between their projections on the line of vehicle movement (e.g., on the ground plane associated with the x-axis and the y-axis) in the straight direction.

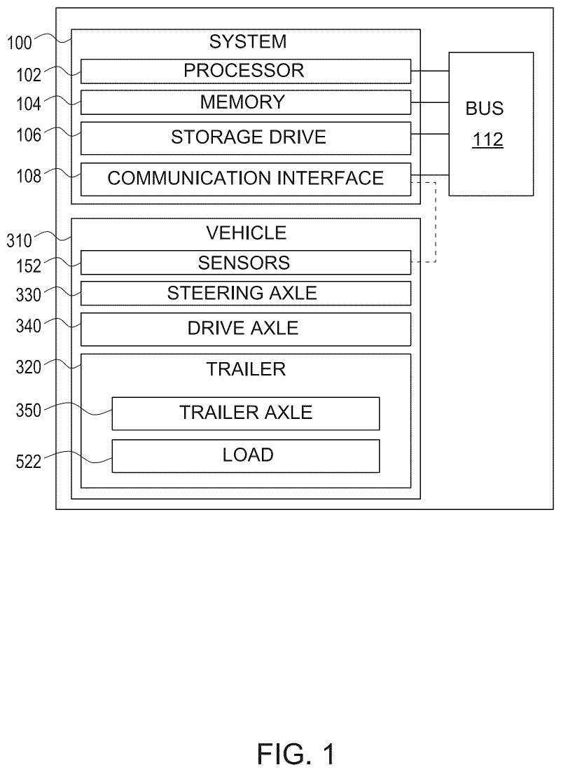

FIG. 1 is an exemplary component diagram of a system 100 for generating axle weight and load distribution value estimates, according to one aspect. The system 100 for generating axle weight and load distribution value estimates may include a processor 102, a memory 104, a storage drive 106, a communication interface 108, an output device (e.g., including a display, a speaker, etc.), and a bus 112. The bus 112 communicatively couples respective components (e.g., processor 102, memory 104, storage drive 106, communication interface 108) of the system and enables computer communication between respective components (e.g., processor 102, memory 104, storage drive 106, communication interface 108) of the system and external components (e.g., sensors 152). The system 100 for generating axle weight and load distribution value estimates may receive measurements from a vehicle 310 (e.g., either by manual input or automatically, via sensors 152 and wired and/or wireless communication). In any event, the vehicle 310 may include one or more sensors 152, one or more axles, such as a steering axle 330, a drive axle 340, etc. Additionally, the vehicle 310 may be coupled to a trailer 320. The trailer 320 may include one or more trailer axle(s) 350 and be utilized to carry a load 522 (e.g., cargo, object, etc.).

### Air-Ride Suspension Pressure

The pressure associated with the air-ride suspension of an axle (e.g., the drive axle 340 of the vehicle 310 or the trailer axle 350 of the vehicle 310) is generally considered to be correlated to a weight on the axle. For example, it is known from Hapyuk et al., U.S. Pat. No. 8,424,892 B2, that there is a relationship between the pressure in an air-ride suspension of a truck or trailer and the weight on the axles. Air pressure measurements may be made at various locations within the air-ride suspension of a truck or trailer using handheld pressure gauges, built-in pressure gauges (particularly for the drive axle 340) and/or pressure sensors (wired and/or wireless). In addition, wireless onboard scales may obtain this information.

According to one aspect, one or more of the sensors 152 may measure the pressure associated with the air-ride suspension of the drive axle 340 or the trailer axle 350 of the vehicle 310, the height of the suspension, etc. and the communication interface 108 may, by wire, or more preferably, wirelessly (e.g., via a wireless network, Bluetooth®, short range communication, etc.) receive the pressure associated with the air-ride suspension of the drive axle 340 or the trailer axle 350 of the vehicle 310 and pass the pressure value to the processor 102. The sensors 152 may also detect other data, such as the fuel level, the DEF level, etc. Additionally, the sensors 152 may transmit any sensed information to an electronic logging device (ELD).

A driver may use various methods to get the weight of the axle or the pressure associated with the air-ride suspension to be used by the processor 102 to calculate results set forth herein based on the formulas described herein. According to one aspect, drivers may use hand-held pressure gauges, built-in pressure gauges, wired and/or wireless pressure sensors, on-board scales, on ground scales and combinations of the foregoing. According to one aspect, the driver may use a hand-held gauge, and take the air pressure measurements in the air-ride suspension via valves that do not require the removal of a cap and input these pressures manually onto the system 100 for generating axle weight and load distribution value estimates via the communication interface 108 (e.g., which may include a touchscreen display, a keypad, etc.).

Further, the markings on the hand-held pressure gauge may measure the height of components of the air-ride suspension, which may help determine whether recalibration is necessary or whether the working level of the air-ride suspension is too high or too low.

The memory 104 may store one or more instructions and the processor 102 may execute one or more of the instructions stored on the memory 104 to perform one or more acts, actions, and/or steps. For example, the processor 102 may receive a pressure associated with an air-ride suspension of an axle of the vehicle 310, such as the drive axle 340 or the trailer axle 350 of the vehicle 310. The processor 102 may receive vehicle information associated with a characteristic of the vehicle 310. The processor 102 may receive load information associated with a load of the vehicle 310.

### Vehicle Information

The vehicle information associated with the characteristic of the vehicle 310 may include at least one of a dimension associated with the vehicle 310, a dimension associated with a component of the vehicle 310, a dimension associated with the trailer 320 coupled to the vehicle 310, or a position associated with the component of the vehicle 310 (e.g., the position and dimensions of the axles of the vehicle 310 and/or the trailer 320, position and dimensions of fuel tanks, DEF tanks, etc., a height of the air-ride suspension, etc.). Examples of components of the vehicle 310 may include a fuel tank, a DEF tank, a fifth wheel, a volume of fuel in the fuel tank, etc. The driver of the vehicle may obtain vehicle information using wired sensors and/or the use of a smartphone camera for recognizing readings of truck and trailer gauges, or other methods of obtaining information.

### Load Information

The load information may include at least one of a position of a load (e.g., which may be cargo, a passenger, fuel in the fuel tank, DEF in the DEF tank, a component of the vehicle such as the fifth wheel, etc.), a weight of the load, a dimension associated with the load, or a distance from a portion of the vehicle 310 to a center of mass of the load. The load may include at least one of a fuel tank, fuel in the fuel tank, an additive to the fuel in the fuel tank, a passenger, a fifth wheel, or cargo.

### Coefficient of Weight Distribution

The processor 102 may calculate one or more coefficient of weight distributions for one or more objects, loads, or components associated with the vehicle 310. In one implementation, during calibration, weighing with an empty trailer, it is best to put its tandems in the front position so that in the future it is possible to more easily determine the position of the center of mass of the cargo. It is also appropriate to measure the distance between the positions of the fifth wheel pin and the middle between the axles of the tandem trailer, which is in the frontmost position. This measurement can be used to determine the position of the center of mass of the cargo in the trailer. If the trailer is not fully loaded and there is an opportunity to add one or more slots to the driver, it is appropriate to put the trailer tandems in the front position to evenly distribute the load and determine the position of the center of mass of the load in the trailer. In this case, the processor can calculate the weight resting on the fifth wheel and the weight of the tandem trailer in the forward position. Knowing these parameters for an empty trailer, it is easy to program how much their weight increased under the influence of the weight distribution of the cargo in the trailer. In the latter, the distance between the positions of the fifth wheel and the tandems in the forward position will be preserved, then the processor can easily calculate the position of the center of mass of the cargo in the trailer. This can be very useful for the successful developing of associated transportation when approximate mass of partials and the location of the center of mass are known.

For example, the coefficient of weight distribution for an object relative to the drive axle 340 of the vehicle 310 may be calculated as:

$$K = \frac{dist}{base}$$

where dist is the distance between a location of a center of a tire or wheel on the steering axle 330 (in a straight orientation or position) and a location of a center of gravity of an object (e.g., a load) or described point measured on the line of vehicle movement in a straight direction; and
where base is a length of the base of the vehicle 310 (not including the trailer 320). The projection of a distance between the center of the front wheel and the middle between the drive axle(s) 340 to the line of vehicle movement in the straight direction.

A distance from the center of the tire or wheel on the steering axle 330 to the center of gravity of the fuel in fuel tanks of the vehicle 310 may be calculated by the processor 102 as:

$$x = ( c a + eb ) / ( a + b )$$

where:
   a is a length of a fuel tank on a driver side of the vehicle 310;
   b is a length of the fuel tank on a passenger side of the vehicle 310;
   c is a projection of distance between the center of the front wheel and the middle of the length of the fuel tank located on the driver side of the vehicle 310 to the line of vehicle movement in the straight direction, and
   e is a projection of distance between the center of the front wheel and the middle of the length of the fuel tank located on the passenger side to the line of vehicle movement in the straight direction.

The coefficient for the fuel weight distribution for the vehicle 310 may be calculated by the processor 102 as:

$$K ( fuel ) = \frac{x}{base}$$

The coefficient for the distribution of weight of DEF, when present, may be calculated by the processor 102 as:

$$K ( DEF ) = \frac{y}{base}$$

where y is a projection of a distance between a center of the front wheel and a center of gravity of the DEF (e.g., middle of the length of the DEF tank) to the line of vehicle movement in the straight direction.

The coefficients for passengers are calculated by the processor 102 as:

$$K ( passengers ) = \frac{z}{base}$$

where z is the distance between a center of the front wheel and a center of gravity of the person or passenger in the driver seat on the line of vehicle movement in the straight direction.

The coefficient of weight distributed for the fifth wheel in a position n of a number of positions may be calculated by the processor 102 as:

$$K ( n ) = \frac{p ( n )}{base}$$

where n is a number of available holes or positions for sliding of the fifth wheel between a cab and the first sliding pin of the corresponding position; and
where p(n) is a distance between the locations of the center of the front wheel and a center of the pin that holding of the weight of the fifth wheel in the nth-position of the fifth wheel measured on the line of vehicle movement in the straight direction.

In this regard, all numbers p(n) form an arithmetic sequence because p(n)=p(0)+n*d, where d is the shortest step (e.g., distance) for sliding of the fifth wheel. Thus, the following formula is derived:

$$K ( n ) = \frac{p ( n )}{base} = \frac{( p ( 0 ) + n * d )}{base} = K ( 0 ) + n * \frac{d}{base}$$

Thus, K(n) is also a member of other arithmetic sequences with a step of d/base. If a user measures the distance d and base and the user estimates any of the base coefficients K(n), the system 100 for generating axle weight and load distribution value estimates may determine the coefficient of weight distribution for any and/or all positions of the fifth wheel. This enables an easy calculation for the coefficient of weight distribution for any position of the fifth wheel. The coefficient of the weight distribution for the particular position of the fifth wheel may be estimated by measuring of the axle weight by the processor 102 as:

$$K ( n ) = ( m 1 - m 2 ) / ( M 1 - M 2 )$$

where (M1−M2) is the difference in weight placed on (e.g., borne by) the fifth wheel during two weighing operations, and (m1−m2) is the difference of the weight measured on the drive axle for the two different weights (different loads or removed partial loads) during the two different weighing operations (all parameters—fuel load, weight of driver etc. being the same).

### Calibration

According to one aspect, a first weighing operation may be done with an empty trailer (e.g., the weight of the vehicle 310 with full tanks of fuel (and DEF, if appropriate) with an empty trailer 320. The trailer tandems need to be in the front position. A second weighing operation may be done shortly thereafter with a loaded trailer (e.g., with a heavy load) to determine the coefficients of the weight distribution for one or more positions of the fifth wheel. A third weighing operation may be done for the vehicle 310 without a trailer 320 with full tanks of fuel (and DEF, if appropriate). As discussed herein, the first weighing operation may be referred to as a calibration and any results associated with the calibration may be stored on the storage drive 106 for easy or quick access and computation of any of the weight value estimates, load distribution value estimates, suggested actions, etc. For accurate results, other weight factors may be held the same or maintained (e.g., the top level of DEF, the top level of fuel in the fuel tanks of the vehicle 310, the top level of fuel in a fuel tank on the trailer, the weight of the driver and the passenger, etc.) when the three weighing operations are conducted.

During calibration, distances may be measured to facilitate computation of the weight value estimate or load distribution value estimate, such as a length of the base, a, b, c, e, d, y, z, dist and distances between pins for fifth wheel and middle of trailer tandems in front position. Additionally, axle weight measurements obtained at a certified scale, first with the vehicle 310, second with the vehicle 310 and an empty trailer, and third with the vehicle 310 and the loaded trailer may be utilized as a ground truth or a reference in any of the equations discussed herein. Further, the configuration or position of the fifth wheel, weights of passengers and/or drivers, total capacity of fuel tanks on the vehicle 310, DEF tank capacity, base length, the length and position of the fuel tank(s) on the vehicle 310, the length and position of the DEF tank(s), distances between fifth wheel positions, the distance between holes to move the tandem of the trailer 320, the coefficient of distribution of the weight that is leaning on the fifth wheel for a single position of the fifth wheel, the ideal weight of the front axle and drive axle(s) 340 with full fuel tanks and DEF may be calculated by the processor 102 by subtraction influence of the load on the fifth wheel, trailer weight without load, etc. may be provided as an input during the calibration.

In another embodiment, the method further comprises receiving, by the processor, legal weight limit data for the steering axle, the drive axle, and the trailer axle, comparing, by the processor, the real-time weight estimates to the legal weight limit data, determining, by the processor, whether any of the real-time weight estimates exceed the legal weight limit data, and generating, by the processor, a compliance notification indicating whether the vehicle is operating within legal weight limits.

### Weight Value Estimate

According to one aspect, the processor 102 may calculate a weight value including at least one of a gross weight of the vehicle 310, a single-axle weight for the vehicle 310, or a tandem-axle weight for the vehicle 310 based on the pressure, the vehicle information, the load information, and/or corresponding coefficient of weight distributions. The processor 102 may determine a legal limit determination of whether the weight value is in accordance with a legal limit and notify a user of the legal limit determination. For example, the processor 102 may receive a GPS location of the vehicle's current location, destination information, etc. to determine the legal limits applicable to the vehicle 310 and ensure compliance with all legal limits associated with the route. The processor 102 may generate different types of suggested actions based on the legal limit determination and/or the pressure, the vehicle information, and the load information.

The suggestions or suggested actions may be determined by the processor 102 based on the legal limit (e.g., as a given or as an input), one or more inputs (e.g., the pressure associated with the air-ride suspension at one of the axles, the vehicle information, and the load information), and solving one or more of the equations described herein based on a change in position for one of the loads, a change in configuration for the vehicle fifth wheel positioning, etc. According to one aspect, inputs may be provided automatically or manually via a software application or “app” on a mobile device (e.g., smartphone or other portable device) and outputs may be provided by an output device (e.g., which may be the same mobile device).

Further, the processor 102 may summarize the influence of each weight factor utilized in the calculation to the axle weight of the vehicle 310 and present (e.g., display notification, text message, email, notify, audio notification, text notification, etc.) useful information about these factors to the driver via the output device. For example, the processor 102 may calculate the weight that is bearing on the fifth wheel and provide additional information or suggestions (e.g., an estimate of the weight on the steering axle 330 with any type of suspension or weight of the cargo in trailer). Further, the processor 102 may generate or render video guides for the driver of the vehicle 310 demonstrating the suggested actions.

When the vehicle 310 (e.g., bobtail vehicle or the vehicle 310 without the trailer 320) is weighed on a scale, the weight of each of the drive axles is not equal because of the manner in which the vehicle 310 is constructed. This imbalance also has an influence on the weight attributed to the steering axle 330. Thus, for convenience, the processor 102 may use hypothetical ideal numbers of the base weight for the steering axle 330 and drive axle 340, which predict the equal weight of the drive axle(s) 340 to each other.

To estimate such parameters, it may be desired to measure an axle weight of the loaded vehicle 310 with full tanks of fuel and DEF (if applicable), and subtract the influence of the weight that is borne on the fifth wheel to the steering axle 330 (M(steering base) and drive axle 340 (M(drive base)) because the coefficient of weight distribution is used for such positions.

The weight of the front part of the trailer 320 that is bearing on the fifth wheel may be calculated by the processor 102 as:

$$M ( front ) = ( M ( dr ) - ( m ( dr . base ) - dM ( passengers ) * K ( passengers ) - dM ( fuel ) * K ( fuel ) - dM ( DEF ) * K ( DEF ) + M ( fifth ) * ( n - k ) * d / base ) ) / K ( n )$$

where:
M(dr) is the weight of the loaded drive axle 340 that may be estimated by linear dependence from pressure readings taken in the air-ride suspension;
dM(passengers) is the difference of the weight of the driver and passenger between calibration (e.g., the first weighing operation) and a current or second weighing operation;
dm(fuel) is the difference of the weight of fuel during the calibration and the second weighing operation;
dm(DEF) is the difference of the weight of DEF during the calibration and the second weighing operation;
M(fifth) is the average weight of the fifth wheel (typically about 300 lb);
k is the number for position of the fifth wheel during the calibration; and
n is the number for the current position of the fifth wheel.

The weight of the steering axle 330 may be estimated by the processor 102 as:

$$M ( steering ) = M ( St . base ) + M ( front ) * ( 1 - K ( n ) ) - dM ( passengers ) * ( 1 - K ( passengers ) ) - dM ( fuel ) * ( 1 - K ( fuel ) ) - dM ( DEF ) * ( 1 - K ( DEF ) ) - M ( fifth ) * ( n - k ) * d / base )$$

The weight of the drive axle 340 and the trailer axle 350 M(tr) may be estimated by measuring pressure (e.g., from sensors 152) and its correlation with weight.

The gross weight of the vehicle 310 and trailer may be calculated by the processor 102 as:

$$M ( gross ) = M ( steering ) + M ( dr ) + M ( tr )$$

The calculations performed by the processor 102 may be reported in pounds, kilograms, tons, or any other unit, as desired by the user.

The processor 102 may calculate the weight of the empty trailer as M(empty·tr).

The processor 102 may calculate the weight of the vehicle 310 (e.g., bobtail) with any level of fuel, weight of the passengers and position of the fifth wheel as:

$$M ( bob ) = ( m ( dr . base ) + M ( St . base ) - dM ( passengers ) - dM ( fuel ) - dM ( DEF )$$

The processor 102 may determine the weight of the freight inside the trailer 320 as:

$$M ( cargo ) = M ( gross ) - M ( bob ) - M ( empty . tr )$$

Since the weight of the steering axle 330 may be calculated at any position of the fifth wheel, the processor 102 may determine the optimal front position for the fifth wheel (e.g., by performing calculations for each position and taking the optimal calculation). This information may be utilized to make adjustments (e.g., via the processor 102) in order to distribute the weight of the front part of the trailer 320 so steering axle 330 will be legal even if the fuel tanks are full of fuel and the weight of the drive axle 340 is equal to the legal maximum legal limit. For example, given a load and a set of inputs (e.g., the pressure associated with the air-ride suspension, the vehicle information and the load information), the processor 102 may calculate the weight value estimate and/or the load distribution value estimate based on an assumption that the vehicle fuels from a current fuel level to a full fuel level and/or adds additional DEF, for example. If the weight value estimate and/or the load distribution value estimate is not in accordance with a legal limit, the processor 102 may perform additional calculations based on moving the load around to determine a configuration of the weight value estimate and/or the load distribution value estimate that meets the legal limit. The processor 102 may calculate partial amounts of fuel that may be added to the fuel tanks without causing the vehicle 310 to exceed legal road limits.

The processor 102 may determine the legal weight capacity of the loaded vehicle 310 and trailer without moving the fifth wheel and adding fuel as:

$$M ( cap = ( M ( dr . max ) - M ( dr ) ) / K ( fifth ) + M ( tr . max ) - M ( tr )$$

where M(dr·max) is the maximum legal weight of the drive axle 340 of the vehicle 310 and M(tr·max) is the maximum legal weight of the trailer axle 350. This formula is particularly suitable when the position of the fifth wheel is not closer to the cab than its optimal position.

The processor 102 may calculate the portion of the weight of one gallon of fuel is distributed to the drive axle 340 and to steering axle 330 (approximately) using the formulas:

$$Mdr ( 1 gallon of fuel ) = 7.1 lb * K ( fuel )$$

$$Mst ( 1 gallon of fuel ) = 7.1 lb * ( 1 - K ( fuel ) )$$

The processor 102 may provide information to the driver that explains how the weight of the drive axle 340 will change if fuel is added to the fuel tanks as:

$$7.1 lb * K ( fuel ) * r$$

The processor 102 may provide information to the driver that explains how the weight on the steering axle 330 will be affected if fuel is added to the fuel tanks as:

$$7.1 lb * ( 1 - K ( fuel ) ) * r$$

where r is the number of gallons of fuel that the driver may add to the fuel tank.

The processor 102 may provide information to the driver that explains how many gallons of fuel (r) may be added to the fuel tanks when the weight reserve M(dr·reserve) is known on the drive axle 340 and how this value may change the weight of steering axle 330 using the formulas:

$$r = M ( dr . reserve ) / ( 7.1 lb * K ( fuel ) )$$

$$dM ( st . reserve ) = r * 7.1 lb * ( 1 - K ( fuel ) )$$

The processor 102 may provide information to the driver that explains how much it will change the weight of the vehicle axles if the fifth wheel will be moved to the distance:

$$dm = distance * \frac{( M ( front ) + M ( fifth ) )}{base}$$

The processor 102 may provide information to the driver that regarding the weight of the loaded trailer as:

$$M ( loader trailer ) = M ( gross ) - M ( bob )$$

It may be useful for driver to know how many gallons of fuel (r) the driver may add to fill the fuel tanks to the top. The driver may mark on the processor 102 the current level of fuel (Q %) during the weight diagnostic and level during calibration with full tanks Z %. The processor 102 may calculate the total volume of the fuel tanks V, and thus may easily estimate (r) as:

$$R = ( Z \% - Q \% ) * V$$

If the driver adds r gallons of fuel to the fuel tanks, the weight of steering axle 330 may be calculated by the processor 102 as:

$$M ( steering with full fuel tanks ) = M ( steering ) + r * 7.1 lb * ( 1 - K ( fuel )$$

and for drive axle 340:

$$M ( drive with full tanks of fuel ) = M ( steering ) + r * 7.1 lb * K ( fuel )$$

The gross weight of the vehicle 310 with trailer may be determined by the processor 102 as:

$$M ( gross with full tanks of fuel ) = M ( gross ) + r * 7.1 lb$$

Since the weight of the front part of the trailer 320 that is bearing on the fifth wheel may be estimated, it may be useful to calculate/determine the maximum weight of the front part of the trailer that the driver may attach to the fifth wheel without exceeding the weight limit for the drive axle 340. The processor 102 may calculate this information as:

$$M ( front max ) = ( M ( dr \cdot max ) - M ( d r ) ) / K ( n ) + M ( front )$$

Moving the axles of the vehicle 310 and trailer improve fuel efficiency by distributing the weight between the drive and trailer axle(s) 350 more evenly. Most vehicle drivers know how much it may change the weight on the axles if they slide the trailer axle 350 to the nearest position. According to one aspect, the processor 102 may provide an estimate of the weight of the drive axle 340 and trailer axle 350 for the user, and provide information to the user indicative of how many holes to rearrange the trailer axle 350 to make the weight thereon closer to the weight on the drive axle 340 based on one or more of the formulas described herein. Weight adjustments of this nature improve the vehicle fuel efficiency during the trip.

The processor 102 may determine the weight of the rear part of a trailer box that is supported on the trailer tandem axles. The position of the axles of the trailer 320 and/or the vehicle 310 may be provided as an input and the processor 102 may calculate the weight of the trailer box with cargo and the location of its center of mass based on this input. The processor 102 may be programmed to estimate the weight of the trailer tandem axles without the trailer box in order to calculate a predicted distribution with any position of the tandem axles and the fifth wheel of the vehicle 310. In this way, the driver may use the system 100 for generating axle weight and load distribution value estimates to calculate the optimum weight distribution (e.g., when there is approximately equal weight on the drive axle(s) 340 and trailer axle(s) 350).

Thereafter, the driver may use a trailer axle stop device to slide trailer tandems to the calculated optimal position. Measuring the distance between adjacent tandem tapping holes will allow the processor 102 to roughly calculate its optimal position. This will help predict the load distribution before the axles of the trailer 320 move and thus reduce the number of extra vehicle maneuvers and graft wear. This may be achieved by providing the value of the pressure in the suspension or the weight of the drive axle(s) 340 of the vehicle 310 and trailer axle(s) 350 to the system 100 for generating axle weight and load distribution value estimates via the communication interface 108 or via the software application, for example. Further, the processor 102 may calculate the target pressure in the drive axle suspension system, which may correspond to an equal weight distribution between the drive axle(s) 340 and the trailer axle(s) 350 for control by the driver. According to one aspect, it is possible to use a small number of input parameters to calculate in advance the optimum position of tandems and change in weight of the drive axle(s) 340 of the vehicle 310 as well as a dry van trailer or refrigerator trailer. The change in weight of typical axes may be calculated by the processor 102 as:

$$dM / in = ( ( M ( d r ) + M ( t r ) ) / 2 - 1 \; 1000 lb ) * 0.0022058 + 12.6 lb$$

where:
   M(dr) is the weight of loaded drive axle 340 that may be estimated by linear dependence from pressure readings taken in the air-ride suspension; and
   M(tr) is the weight of loaded trailer axle 350 that may be estimated by linear dependence from pressure readings taken in the air-ride suspension.

For example, this may be the weight of the drive axle(s) 340 and axles of the trailer 320 (e.g., which may have two axles and eight wheels). In this regard, the processor 102 may calculate how many holes it takes to move the trailer tandem to get an approximately even load distribution between the axles. Also, if desired, the driver may choose an optimal load distribution between the axles to increase the safety of transportation by changing the appropriate number of holes in the settings for the movement of tandems. Knowing the desired position for tandems from the system 100 for generating axle weight and load distribution value estimates, the driver may quickly move them with a metal stopper that stops the axles in the correct position.

Most well-equipped vehicles have pressure gauges for the drive axles suspension. However, some vehicles do not have such equipment and do not have space to install such gauges. A pressure gauge may be placed in front of the driver behind the wheel because it allows the driver to notice the change in weight of the drive axle(s) 340 if the freight in the trailer 320 has shifted significantly. Therefore, it is appropriate to utilize a smartphone stand in which a pressure gauge for the suspension may be placed. Placing such equipment in the driver's field of vision will solve the problem efficiently without large expenses.

The processor 102 may determine the legal and/or optimal placement of tandem trailers based on the weight value estimate, the center of mass of the load or cargo, and a predicted position of the center of mass of additional cargo to be transported. Typical distances for tandem travel are 4 or 6 inches between holes. This means that the centers of the two tandem travel holes on most American trailers are 12 inches apart.

After the trailer axle(s) 350 have been slidingly moved to the calculated optimum position, the processor 102 may perform a confirmation regarding the difference in weight between the drive axle(s) 340 and the trailer axle(s) 350. For example, this may be achieved because a suspension pressure difference of 1 PSI between a real reading and a suggested target reading generally corresponds to about a 1000 pound difference in weight between drive axle(s) 340 and trailer axle(s) 350. It is possible to use a handheld pressure gauge with wireless communication capacity to verify a suspension pressure in the trailer axle(s) 350 after sliding tandems to confirm that the driver has distributed the weight evenly to improve safety and to save resources such as time, money, and fuel.

The weight of the trailer axle 350 may be calculated by the processor 102 based upon a linear dependence suspension pressure from the axle weight. In one embodiment, the processor 102 may estimate the weight of the trailer tandems without the trailer box, and use this estimate to further estimate the amount of weight the rear part of the trailer 320 leans on the trailer tandems. To do this, the processor 102 may perform calibration weightings to find out the weight of the trailer 320, the weight and location of the trailer axle(s) 350 in the front position, and the weight and location of the trailer axle(s) in the rear position. The calculations performed by the processor 102 are set forth below:

$$Mr 1 = M t r - Mf 1 - Mtd$$

$$Mr 2 = M t r - Mf 2 - Mtd$$

$$Mtr * x = Mr 1 * l 1 = Mr 2 * l 2$$

$$( Mtr - Mf 1 - Mtd ) * l 1 = ( M t r - Mf 2 - Mtd ) * l 2$$

$$( Mtr - Mf 1 ) * l 1 - ( Mtr - Mf 2 ) * l 2 = Mtd ( l 1 - l 2 )$$

$$Mtd = ( ( Mtr - Mf 1 ) * l 1 - ( Mtr - Mf 2 ) * l 2 ) / ( l 1 - l 2 )$$

where:
   Mr1 is the weight of the rear part of the trailer 320 that leans on the trailer tandems during the first weighing with the front position of the tandems;
   Mf1 is the weight of the front part of the trailer 320 that leans on the fifth wheel during the first weighing with the front position of the tandems;
   Mr2 is the weight of the rear part of the trailer 320 that leans on the trailer tandems during the second weighing with the rear position of the tandems;
   Mf2 is the weight of the front part of the trailer 320 that leans on the fifth wheel during the second weighing with the rear position of the trailer tandems;
   Mtr is the weight of the trailer 320 during calibration;
   x is the distance between kingpins of the fifth wheel and location of the center of mass of the trailer box without tandems;
   l1 is the distance between kingpins of the fifth wheel and location of the center between axles of trailer tandems during the first weighing;
   l2 is the distance between kingpins of the fifth wheel and location of the center between axles of the trailer tandems during the second weighing; and
   Mtd is the weight of the trailer tandems without the trailer box.

In this way, the processor 102 may estimate the weight of cargo inside the trailer 320, the weight of the front part of the weight of the trailer 320 that rests on the fifth wheel of the vehicle 310, or the weight of the front axle by inputting variable parameters of the vehicle 310 including volume of fuel in tanks, volume of DEF, or position of the fifth wheel on the vehicle 310 based on the inputs discussed herein.

### Transportation Network

The processor 102, via the communication interface 108, may search for accompanying transportation, such as when the vehicle 310 is over or underloaded. For example, after obtaining qualitative results about the weight of the cargo in the trailer 320, the position of its center of mass, and additional carrying capacity, the processor 102 may track the movement of other vehicles and their destinations to find transit cargo for the ego-vehicle or vehicle. According to one aspect, requestors may be able to enter the desired parameters of their parcel in the search, such as weight, dimensions, and the place of pickup and delivery in order to see a list of vehicles with available capacity are travelling in the desired direction and may perform such a transport task legally and safely.

Most flatbed and step deck trailers are characterized by the use of two spread axles with independent pneumatic suspensions. For drivers, it may be desired to know how to place several loads while observing all weight limits and transportation safety. The weight of each such axles may be determined by weighing or by the pneumatic method, knowing the dependence of pressure on the load. Knowing what the weight of these axles was without load and after placing the load, the processor 102 may determine how much the weight of each of them increased. It is also worth measuring the distance between these axes. This will allow the processor 102 to calculate where the point of application of the weight of the load that falls on the axle of the trailer 320 is located. DM1/l2=DM2/L1; L1+L2=L. Knowing the point of application of such a force and by how much the weight of the load on the spread axles of the trailer 320 has increased and the weight by how much the load on the fifth wheel has increased, the processor 102 may determine the total weight of the load on the trailer 320 and the position of its center of mass as:

$$( DM 1 + DM 2 ) / Lfifth = DMfifth / Lspread ; lfifth + lspread = base + L 1$$

where:
   DM1 is by how much the weight of the front axle of the axle spread increased after loading;
   l2 is the distance from the rear of the spread axles to its imaginary point of application of the weight of the load distributed between the axles of the trailer 320 and the fifth wheel;
   DM2 is by how much the weight of the rear axle of the axle spread increased after loading;
   L1 is the distance from the rear axle of the axle spread to the imaginary point of application of the weight of the load distributed between the axles of the trailer 320 and the fifth wheel;
   L is the distance between the spread axes;
   Lfifth is the distance between the positions of the center of mass of the cargo on the trailer 320 and the foam of the fifth wheel;
   DMfifth is by how much the weight of the fifth wheel increased after loading; and
   Lspread is the distance between the positions of the center of mass of the cargo on the trailer 320 to the point of application of the cargo load, which ensures the available mass distribution between the spread axles.

By providing the weight of all axles of the vehicle 310 and the trailer 320, the processor 102 may calculate the maximum weight the additional load may have and in which range of positions it should be placed on the trailer 320.

### Network Architecture Details

According to one aspect, the system 100 for generating axle weight and load distribution value estimates may be implemented as part of a distributed transportation network architecture comprising a plurality of vehicle computing devices and a central server. Each vehicle computing device may be an on-board truck computer, an electronic logging device (ELD), a mobile device such as a smartphone or tablet, or a GPS navigator configured to execute software instructions for calculating weight value estimates and load distribution value estimates as described herein. The vehicle computing devices communicate with the central server via wireless communication networks, which may include cellular networks (e.g., 4G LTE, 5G), satellite communication systems, or wireless internet connections (e.g., Wi-Fi).

The communication between vehicle computing devices and the central server may utilize secure data transmission protocols to protect sensitive vehicle and cargo information. According to one aspect, the system may employ HTTPS (Hypertext Transfer Protocol Secure) for secure data transmission, ensuring that weight measurements, GPS coordinates, cargo information, and other vehicle data are encrypted during transmission. For real-time updates and bidirectional communication, the system may utilize WebSocket protocol or similar persistent connection technologies, which enable the central server to push notifications and load matching opportunities to vehicle computing devices without requiring the devices to continuously poll the server. This reduces bandwidth consumption and provides near-instantaneous updates when new load opportunities become available or when vehicle status changes require recalculation of available capacity.

The central server maintains a database structure configured to store and efficiently retrieve vehicle capacity information for the plurality of vehicles in the network. According to one aspect, the database may be a relational database, a NoSQL database, or a distributed database system configured to handle high-volume, real-time data updates. The database structure may include vehicle profile records storing static vehicle information such as base length, fuel tank capacity and position, DEF tank capacity and position, fifth wheel positions, trailer tandem configurations, and calibration parameters including weight distribution coefficients. The database may further include dynamic vehicle status records that are continuously updated, storing current GPS location, current axle weights calculated from pressure measurements, current fuel level, current DEF level, current fifth wheel position, current trailer tandem position, cargo weight, cargo center of mass position, available additional load capacity, planned route and destination, and timestamp of last update.

To optimize query performance for load matching operations, the database may be indexed on multiple fields including GPS coordinates (to enable rapid geographic searches for vehicles near pickup locations), available capacity (to filter vehicles with sufficient capacity for requested loads), destination and route waypoints (to identify vehicles traveling in desired directions), and timestamp (to ensure data freshness and remove stale vehicle records). The database structure may also include load request records storing information submitted by shippers or freight brokers, including requested cargo weight, cargo dimensions, pickup location coordinates, delivery location coordinates, pickup time window, delivery time window, and special handling requirements. Historical transaction records may be maintained for machine learning purposes, storing completed load matches, actual versus predicted weight distributions, fuel efficiency impacts, and user feedback on match quality.

According to one aspect, vehicle computing devices may transmit updated vehicle status data to the central server at predetermined intervals (e.g., every 5 minutes, every 10 minutes) or upon occurrence of triggering events such as significant changes in vehicle weight (indicating loading or unloading of cargo), changes in GPS location indicating route deviation or arrival at waypoints, changes in fifth wheel or trailer tandem position, or detection of available capacity exceeding a threshold amount. The central server processes the received vehicle status data to update the database and trigger recalculation of load matching opportunities as described further herein.

### Deadhead Mile Reduction Calculations

One significant advantage of the distributed transportation network is the reduction of deadhead miles—miles traveled by a vehicle with an empty or partially-loaded trailer. Deadhead miles represent wasted fuel, lost revenue opportunity, and unnecessary environmental impact. The processor 102 of the central server may be configured to calculate deadhead mile savings for potential load matches by comparing vehicle routes with and without acceptance of a partial load.

According to one aspect, when the central server receives a load request specifying a pickup location, delivery location, and cargo parameters, the processor 102 identifies vehicles in the network having available additional load capacity as determined by the weight value estimation methods described herein. For each identified vehicle, the processor 102 calculates a baseline route distance from the vehicle's current location to its planned destination without accepting the load. The processor 102 then calculates an alternative route distance that includes a deviation to the pickup location, travel from the pickup location to the delivery location, and continuation from the delivery location to the vehicle's original planned destination. The route deviation distance may be calculated as the difference between the alternative route distance and the baseline route distance.

The processor 102 may calculate the deadhead mile reduction metric by determining how many miles of the alternative route would be traveled with revenue-generating cargo versus empty miles in the baseline scenario. For example, if a vehicle is traveling from point A to point C (destination) and a load is available from point B to point D, where point B is near the vehicle's current route and point D is near or beyond point C, the processor 102 calculates: (1) baseline empty miles as the distance from current location to point C; (2) alternative route including distance from current location to point B (still empty), distance from point B to point D (loaded with partial load), and distance from point D to point C (potentially still empty or with reduced empty distance if point D is closer to or beyond point C); and (3) deadhead mile reduction as the difference between loaded miles in the alternative route and loaded miles in the baseline route. The processor 102 may weight this calculation based on the revenue potential of the load and the additional fuel consumption required for the route deviation.

According to one aspect, the processor 102 may calculate a normalized efficiency score for each potential load match by dividing the revenue potential of the load by the sum of route deviation distance and fuel cost increase due to additional weight. This efficiency score enables ranking of multiple load opportunities to present the most economically and environmentally beneficial options to drivers. The processor 102 may also consider time constraints, calculating whether acceptance of a partial load would cause the vehicle to arrive late at its original destination, and may filter out load opportunities that would violate delivery commitments.

The processor 102 may calculate a longitudinal position of the center of mass of the trailer box and the cargo loaded thereon without tandems according to the following formula:

$$L = ( M ( front ) \times A + M ( tandems ) \times B ) / ( M ( front ) + M ( rear ) )$$

where:
   M(front) is the weight of the front portion of the trailer bearing on the fifth wheel;
   M(rear) is the weight of the rear portion of the trailer bearing on the tandem axles;
   M(tandems) is the weight of the trailer tandems without the trailer box;
   A is the distance between the kingpin and the center position between the tandem axles of the trailer; and
   B is the distance between the kingpin and the center of mass of the trailer box without the tandems.

### Load Matching Algorithm Specifics

The processor 102 of the central server executes a multi-stage load matching algorithm to identify compatible vehicles for each load request and to rank identified vehicles according to optimization objectives. The matching algorithm applies a series of filtering criteria followed by a ranking methodology to generate an ordered list of vehicle recommendations.

In a first filtering stage, the processor 102 applies weight capacity filtering by comparing the requested cargo weight from the load request against the available additional load capacity stored in the database for each vehicle. The available additional load capacity is calculated in real-time based on current axle weights, legal weight limits for the relevant jurisdictions along the vehicle's route, and potential weight increases from planned fueling. Vehicles having available additional load capacity less than the requested cargo weight are eliminated from consideration. According to one aspect, the processor 102 may apply a safety margin to this comparison, requiring that available capacity exceed the requested weight by a predetermined threshold (e.g., 500 pounds, 1000 pounds) to account for measurement uncertainties and to provide a buffer against weight limit violations.

In a second filtering stage, the processor 102 applies spatial constraint filtering by determining whether the requested cargo can be physically accommodated within the available space in each vehicle's trailer. The processor 102 utilizes the stored cargo center of mass position and cargo dimensions for existing loads to calculate available spatial regions within the trailer. According to one aspect, the processor 102 may model the trailer as divided into discrete zones and determine which zones are currently occupied by existing cargo based on the center of mass position and dimensions. The processor 102 compares the requested cargo dimensions against the available zones to verify that sufficient contiguous space exists. Additionally, the processor 102 may verify that placement of the additional cargo in available zones would not cause the combined center of mass of all cargo to shift outside permissible bounds that would violate weight distribution requirements when the trailer tandems are optimally positioned.

In a third filtering stage, the processor 102 applies route alignment filtering by calculating geographic alignment between each vehicle's planned route and the pickup and delivery locations specified in the load request. According to one aspect, the processor 102 determines whether the pickup location is within a predetermined maximum deviation distance (e.g., 50 miles, 100 miles) from the vehicle's current route between its current location and destination. The processor 102 may employ geographic information system (GIS) techniques or mapping APIs to calculate the shortest route incorporating the pickup location and compare this route distance to the baseline route distance. If the route deviation exceeds the predetermined threshold, the vehicle is eliminated from consideration. Similarly, the processor 102 verifies that the delivery location does not require excessive backtracking or deviation from the vehicle's ultimate destination.

In a fourth filtering stage, the processor 102 applies time window filtering by comparing the pickup time window and delivery time window specified in the load request against the vehicle's estimated arrival times at the pickup and delivery locations. The processor 102 calculates estimated time of arrival at the pickup location based on the vehicle's current GPS location, current speed or average speed, and distance to the pickup location. If the estimated arrival time falls outside the specified pickup time window, or if accepting the load would cause the vehicle to violate the delivery time window or the vehicle's original destination arrival commitment, the vehicle is eliminated from consideration. According to one aspect, the processor 102 may account for hours-of-service regulations and required rest breaks when calculating estimated arrival times to ensure compliance with driver safety regulations.

After applying the filtering stages, the processor 102 ranks the remaining compatible vehicles using a multi-objective ranking methodology. According to one aspect, the ranking methodology assigns a composite score to each vehicle based on weighted combinations of multiple optimization objectives. A first optimization objective may be deadhead mile reduction, calculated as described above, where higher deadhead mile reduction results in higher scores. A second optimization objective may be revenue per mile improvement, calculated by dividing the expected revenue for the partial load by the total additional miles required (including route deviation), where higher revenue per mile results in higher scores. A third optimization objective may be weight distribution balance, where vehicles that would achieve more balanced weight distribution between drive axles and trailer axles after accepting the load receive higher scores, since balanced distribution improves fuel efficiency and reduces tire wear. A fourth optimization objective may be environmental impact, calculated based on estimated fuel consumption reduction from deadhead mile reduction and optimal weight distribution, where greater environmental benefit results in higher scores.

The processor 102 may apply predetermined weighting factors to each optimization objective and calculate the composite score as a weighted sum. According to one aspect, the weighting factors may be configured by system administrators, individual carriers, or individual drivers to reflect their priorities. For example, a carrier prioritizing environmental sustainability may assign higher weight to the environmental impact objective, while a carrier prioritizing profitability may assign higher weight to the revenue per mile objective. The processor 102 sorts the compatible vehicles in descending order of composite score and selects a predetermined number of top-ranked vehicles (e.g., top 5 vehicles, top 10 vehicles) to receive load matching notifications.

According to one aspect, the processor 102 may implement a fairness algorithm to prevent the same vehicles from consistently receiving the highest-priority load opportunities. The fairness algorithm may track historical notification frequency for each vehicle and apply a penalty factor to vehicles that have recently received multiple notifications, thereby distributing opportunities more evenly across the vehicle fleet. This encourages broader network participation and prevents driver dissatisfaction from perceived unfairness in load allocation.

### Real-Time Synchronization and Consistency Management

The distributed nature of the transportation network requires robust real-time synchronization mechanisms to ensure that vehicle capacity information remains accurate and that load matching decisions are based on current data. According to one aspect, vehicle computing devices are configured to detect triggering events that indicate changes in vehicle status requiring synchronization with the central server. Triggering events may include detection of weight changes exceeding a predetermined threshold (e.g., 500 pounds, 1000 pounds), indicating loading or unloading of cargo; changes in GPS location indicating significant progress along the planned route or deviation from the planned route; manual updates by the driver to planned destination or route; changes to vehicle configuration such as fifth wheel position or trailer tandem position; and expiration of a maximum update interval (e.g., 10 minutes, 15 minutes) since the last synchronization.

Upon detection of a triggering event, the vehicle computing device executes the weight calculation methods described herein to determine current axle weights based on current pressure measurements from air-ride suspension sensors. The vehicle computing device calculates updated values for cargo weight, cargo center of mass position, and available additional load capacity using the equations and methods previously described. The vehicle computing device packages this updated information along with current GPS coordinates, timestamp, and vehicle configuration parameters into a data transmission and transmits the data to the central server via the wireless communication network using the secure transmission protocols described above.

The processor 102 of the central server receives the updated vehicle status data and updates the corresponding vehicle status record in the database. According to one aspect, the processor 102 implements a timestamp-based consistency mechanism to handle potential race conditions where multiple updates for the same vehicle arrive out of order due to network latency variations. The processor 102 compares the timestamp of the received update against the timestamp of the currently stored vehicle status record and only applies the update if the received timestamp is more recent than the stored timestamp. This prevents stale data from overwriting more current information.

Upon updating a vehicle status record, the processor 102 determines whether the update affects any pending load matching operations. According to one aspect, if the available additional load capacity for the vehicle has changed significantly (e.g., decreased below a threshold or increased above a threshold), the processor 102 triggers re-evaluation of active load requests to determine whether the vehicle should be added to or removed from the set of compatible vehicles for those requests. If the vehicle's GPS location has changed such that route alignment with pending load requests has improved or degraded beyond predetermined thresholds, the processor 102 similarly triggers re-evaluation and potentially updates the ranking of vehicles for affected load requests.

To handle scenarios where multiple load requests target the same vehicle, the processor 102 implements a reservation and locking mechanism. According to one aspect, when the processor 102 transmits a load matching notification to a driver's mobile device for a particular load request, the processor 102 creates a temporary reservation record in the database indicating that the vehicle's available capacity is potentially allocated to that load request. The reservation has a predetermined expiration time (e.g., 15 minutes, 30 minutes) during which the driver may review the load details and decide whether to accept. During the reservation period, the processor 102 accounts for the potentially-allocated capacity when evaluating the vehicle's eligibility for other load requests. If the driver accepts the load, the processor 102 converts the reservation to a confirmed allocation, updates the vehicle's cargo weight and available capacity accordingly, and removes the vehicle from consideration for conflicting load requests. If the driver declines the load or the reservation expires without acceptance, the processor 102 deletes the reservation record and restores the vehicle's full available capacity for matching with other loads.

According to one aspect, if multiple drivers accept load opportunities simultaneously such that their combined acceptance would over-allocate a vehicle's capacity, the processor 102 implements a first-acceptance priority mechanism. The processor 102 timestamps each acceptance message received from driver mobile devices and grants the load to the driver whose acceptance was received first. The processor 102 transmits a notification to the other drivers indicating that the load is no longer available and updates their vehicle capacity information to reflect the confirmed load allocation. This first-acceptance mechanism provides a fair and transparent resolution to conflicting acceptances while maintaining system consistency.

The real-time synchronization architecture enables the transportation network to respond dynamically to changing conditions such as traffic delays, vehicle breakdowns, or last-minute load cancellations. When a driver updates their planned route or destination through their mobile device interface, the updated information is immediately transmitted to the central server, triggering re-evaluation of that vehicle's compatibility with pending load requests and potentially enabling new matching opportunities that were not previously feasible. This dynamic responsiveness maximizes the utilization of available vehicle capacity across the network and minimizes wasted deadhead miles.

### Additional Advantages and Benefits

In this way, advantages including determining whether vehicles and trailers meet legal weight limits on the road benefits carriers because may save fuel, and reduce the number of trips required to deliver partial loads because vehicles and trailers may be loaded to full legal capacity may be provided. Vehicle drivers will have fewer fines because they may determine that there is a sufficient weight reserve on each axle.

Another implementation of the method allows drivers to get more fuel to the fuel tanks and still be legal on the road. At present, vehicle drivers must use certified scales to find out the weight of the vehicle axles. The method is of most importance when the gross weight of the vehicle 310 and trailer are close to the maximum legal limit. It is well known that the weight of one gallon of fuel in the fuel tanks is about 7 pounds. But most of the drivers do not know how this weight in tanks is distributed between the vehicle axles. So, to avoid having the axles being overweight, vehicle drivers routinely assume that total weight of added fuel may increase the weight of the drive axle 340. Such an assumption is not accurate because the fuel tanks are located between the vehicle's drive and steering axle(s) 330, and thus part of the weight of the fuel is distributed to the steering axle 330. Vehicle drivers thus pump less fuel in the fuel tanks than is legally permissible (i.e., when the drive axle 340 still has enough of a weight reserve). This leads to drivers making more fuel stops than are necessary, which wastes time.

Measuring the distances that determine the length of the fuel tanks and their location on the vehicle 310 may help predict how the weight of added fuel will be distributed between the axles. The possible results may be calculated by the processor 102.

Another implementation of the method utilizes GPS and online fuel pricing to advise the driver of the truck where to purchase fuel and the amount of fuel to purchase in order to minimize the expense for purchasing fuel. The implementation involves consideration of the price of the fuel, the amount of fuel required for the trip (or next fuel stop) and the amount of fuel that can be added to the tank without exceeding load limits, which leads to use of less fuel and cost savings to the driver.

Another advantage of methods according to the invention is that weight value estimations can be made when the load is placed into the trailer by the driver on location. If the weight value exceeds a predetermined weight used for determining the fee or price for transportation, the driver can request additional compensation for the additional weight of the load placed on the trailer or refuse to transport it.

Another advantage provided by methods of the invention is that load value estimates can be obtained quickly (on site and in near real time) as partial loads are placed onto or removed from the trailer. This allows the driver to determine whether additional partial loads can be picked up during transit, which minimizes the number of partial loads that must be hauled and saves fuel.

Another advantage provided by methods of the invention is that over time, changes in fuel usage and other characteristics can be monitored to determine whether maintenance and/or service should be performed on the vehicle.

Yet another advantage is that over time, the vehicle information saved in memory allows for calculations to be made after the trailer is loaded (no empty weight must be acquired to make load calculations). Furthermore, calibrations can be updated based on measurements taken at certified scales without the need for acquiring empty weight measurements.

### Software Application

The processor 102 may function on a smartphone to run a software application, which may receive respective inputs discussed herein, provide drivers with directions on how to perform periodic control inspection of the vehicle 310 and trailer, record the performance of this routine by using a camera or other communication methods, and provide one or more outputs such as suggested actions, notifications, guides, etc. The processor 102 may help freight carriers to reduce repair costs on the road and increase safety scores due to periodic review and control of the condition of the vehicles and trailers.

### Suggested Action—Load Management

The processor 102 may advise drivers regarding the pressure values to be obtained in the air-ride suspensions when there is a maximum weight on the axle, and/or recommended a maximum value of pressure that will ensure a safe axle weight reserve. These results may be provided for both the drive axle 340 and the trailer axle 350. For example, the processor 102 may generate a suggested action pertaining to the load based on determining the legal limit determination to not be in accordance with the legal limit.

In this regard, the processor 102 may determine the weight of the freight, cargo, or load in the trailer 320 and the weight capacity for additional partial loads that may be added without the axles becoming overweight, determine the possible weight capacity of the loaded vehicle and trailer without moving the fifth wheel and adding the fuel to picking up additional partial loads, determine the weight of the front part of the trailer 320 that is leaning on the fifth wheel and the weight capacity of the fifth wheel to determine whether the drive axle 340 of the particular vehicle will be legal on the road with a particular trailer and freight loaded in it, determine the gross weight of the loaded vehicle and trailer to follow the legal weight limits on the road, determining the projected weight of the loaded vehicle and trailer and their axles after possible fueling to full tank capacity, determine the weight of the freight, cargo, or load inside the trailer 320 for possible reloading of it or adding more freight, cargo, or load to the trailer 320 based on the above discussed inputs (e.g., pressure, vehicle information, load information, etc.). The processor 102 may also estimate of the weight of a loaded trailer and the vehicle 310 without the trailer 320 for determining whether a particular vehicle may be connected to a particular trailer after sliding the axles without exceeding the legal weight limits on the road, estimate the legal weight capacity that may be attached to the fifth wheel, estimate the projected weight of the vehicle axles and gross weight of the vehicle 310 and loaded trailer after possible fueling to the maximum capacity of the fuel tanks, estimate the weight of the freight inside the trailer 320 for future reloading partial loads or for adding freight to the trailer 320, etc. This enables the vehicle 310 to be legal on the road during the trip, including immediately and/or after refueling.

### Suggested Action—Fifth Wheel Configuration

As another example, the processor 102 may generate a suggested action pertaining to a fifth wheel vehicle configuration based on the pressure, the vehicle information, and the load information (e.g., by moving the trailer axle 350 to meet legal weight limits and improve the fuel efficiency by distributing the weight between the drive axle 340 and trailer axle 350 more evenly, by determining whether the axles of the particular vehicle and any particular loaded trailer may be moved (e.g., via sliding) properly to meet legal weight limits on the road and, if so, by how much, by sliding the fifth wheel to the optimal position for near-permanent usage).

### Change Simulator and Load Distribution Value Estimate

Further, the processor 102 may assist the driver of the vehicle 310 with how a potential change would affect the legality of the vehicle 310 in terms of axel weight and/or load distribution. For example, the processor 102 may receive a potential change associated with the vehicle information or a potential change associated with the load information, calculate a load distribution value estimate based on the pressure, the potential change associated with the vehicle information and/or the potential change associated with the load information, and/or corresponding coefficient of weight distributions, and determine a legal limit determination of whether the load distribution is in accordance with a legal limit and notify a user of the legal limit determination based on one or more of the equations and/or formulas described herein.

Further, the processor 102 may summarize the influence of each potential change utilized in the calculation to the axle weight of the vehicle 310 and display additional information, such as suggestions (e.g., in the form of video tutorials, etc.), about these factors to the driver via the output device.

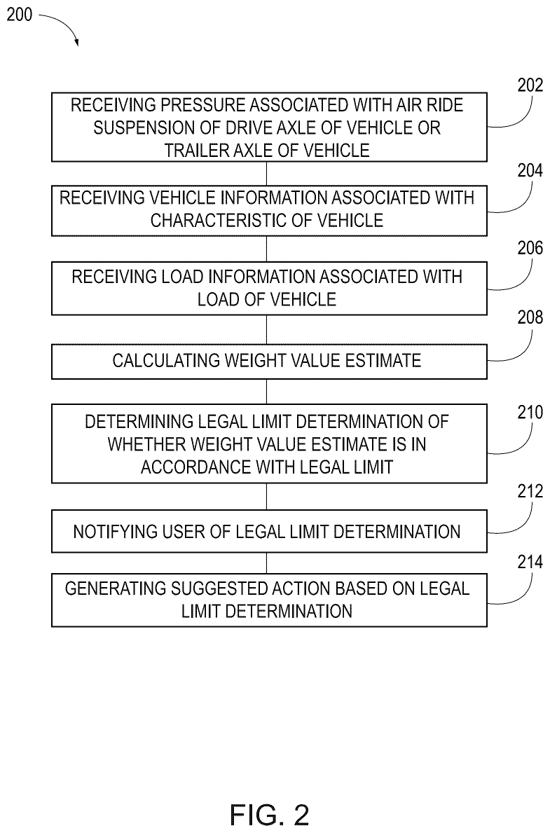

FIG. 2 is an exemplary flow diagram of a method 200 for generating axle weight and load distribution value estimates, according to one aspect. The method 200 for generating axle weight and load distribution value estimates may be implemented at least in part on a computer via a processor, a memory, a storage drive, etc., and may include receiving 202 a pressure associated with an air-ride suspension of a drive axle of a vehicle or a trailer axle of the vehicle, receiving 204 vehicle information associated with a characteristic of the vehicle, receiving 206 load information associated with a load of the vehicle, and calculating 208 a weight value estimate including at least one of a gross weight of the vehicle, a single-axle weight for the vehicle, or a tandem-axle weight for the vehicle based on a calibration, the pressure, the vehicle information, and the load information. The method may include determining 210 a legal limit determination of whether the weight value estimate is in accordance with a legal limit and notifying 212 a user of the legal limit determination and generating 214 a suggested action based on determining the legal limit determination to not be in accordance with the legal limit or based on the pressure, the vehicle information, and the load information. The suggested action may pertain to moving the load from a first position to a second position within the semi-trailer or reconfiguring the vehicle or tractor's fifth wheel positioning.

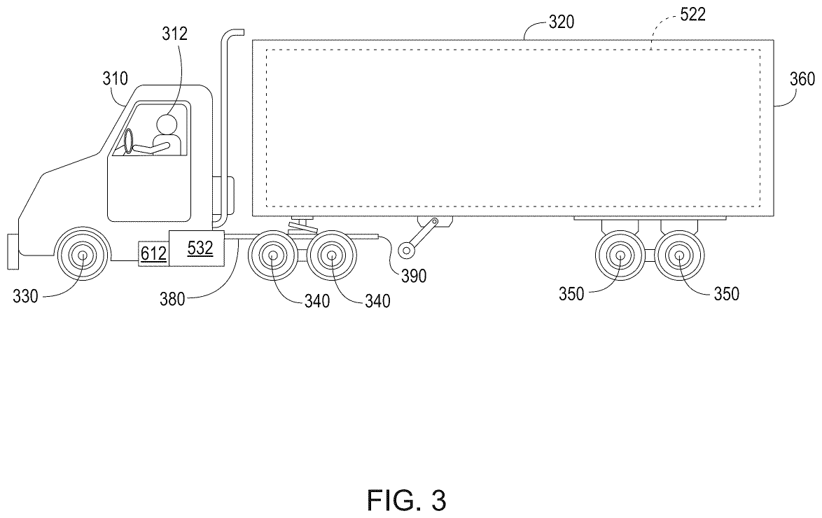

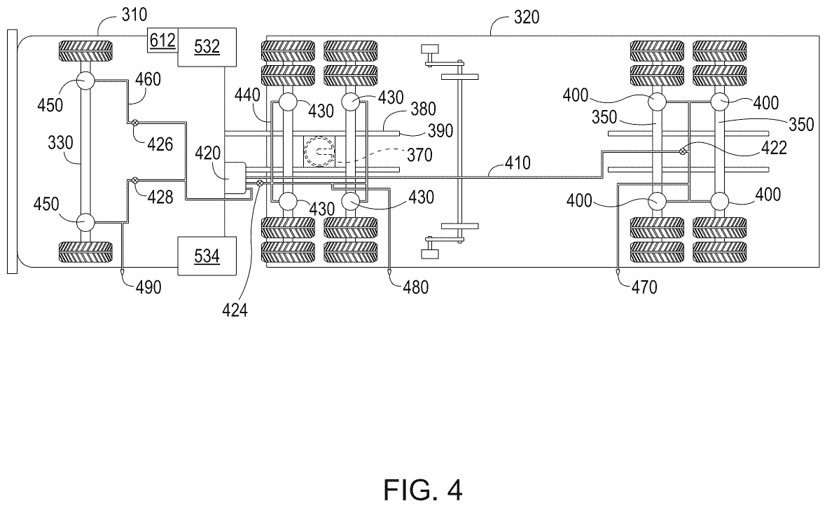

FIG. 3 is an exemplary schematic side view of a vehicle and a semi-trailer on which the system and method for generating axle weight and load distribution value estimates may be implemented, while FIG. 4 is an exemplary schematic bottom plan view of the vehicle and the semi-trailer of FIG. 3, according to one aspect.

For example, an exemplary vehicle 310 having a semi-trailer 320 coupled thereto is shown in FIGS. 3 and 4. The vehicle 310 includes a steering axle 330 and a drive axle 340. In the illustrated embodiment, two rear axles collectively comprise the drive axle 340, although any number of rear axles may be implemented. The vehicle 310 and semi-trailer 320 are used in the illustrations because this is a common vehicle type used to haul freight. A driver 312, a fuel tank 532, a DEF tank 612 and a load 522 are shown in FIG. 3. The fuel tank 534 on the passenger side of the vehicle 310 is shown in FIG. 4.

The semi-trailer 320 includes a trailer axle 350. In the illustrated embodiment, the trailer axle 350 comprises a tandem or pair of axles. It will be appreciated that other arrangements and numbers of axles or groups of axles could be implemented (e.g., greater or fewer number of axles). In the illustrated embodiment, the trailer axle 350 is adjustable forward or back relative to the rear 360 of semi-trailer 320 to redistribute weight on the axles.

The steering axle 330 and the drive axle 340 of the vehicle 310 are fixed relative to each other. As seen in FIGS. 3 and 4, the vehicle 310 includes a fifth wheel 370, which is adapted to be slidably adjustable on the frame 380 of the vehicle 310 forward or back relative to the rear 390 of the vehicle 310. By moving the trailer axle 350 and/or the fifth wheel 370, weight may be redistributed between the trailer axle 350, the drive axle 340 and the steering axle 330.

With reference to FIG. 4, the semi-trailer 320 includes an air-ride suspension that includes air bags 400. The air bags 400 are supplied with air through a line 410, which extends from an air reservoir or tank 420 mounted to the vehicle 310. The air-ride suspension typically includes an air leveler. The air bags 400 are interconnected together and isolated from the line 410 using a valve 422.

Additionally, the vehicle 310 also includes an air-ride suspension. Sometimes, the air-ride suspension only includes air bags 430 for the drive axle 340, which are supplied with air through a line 440 that extends from the air reservoir or tank 420. But in other embodiments, the air-ride suspension further comprises air bags 450 for the steering axle 330, which are supplied with air through a line 460 that extends from the air reservoir or tank 420. The air bags 430 are interconnected together and isolated from the line 440 using a valve 424. The air bags 450 are generally not connected together, but rather each (left and right) is isolated from the line 460 using a valves 426, 428.

According to one embodiment, at least one air fitting 470 is installed in an isolated portion of the air-ride suspension system of the trailer 320 that includes an air bag 400. According to one aspect, at least a second air fitting 480 is installed in the isolated portion of the air-ride suspension system for the vehicle 310 that includes the air bags 430. Optionally, an additional air fitting 490 may be installed in the isolated portion of the air-ride suspension system for the vehicle 310 that includes an air bag 450. In the illustrated embodiment shown in FIG. 4, only one air fitting 490 is installed. It will be appreciated that an air fitting could be installed in both the left and the right isolated portions of the vehicle 310 containing air bags 450.

The air fittings 470, 480, 490 may be Schrader valves, for example. But other types of air fittings may be utilized, if desired. The air fittings 470, 480, 490 may be installed on the operator's side of the vehicle 310 in a location that is easily accessible to the operator while the operator is standing on the ground next to the vehicle 310 and semi-trailer 320. The air fittings 470, 480, 490 permit the operator to accurately and quickly measure the air pressure in each of the isolated portions of the air-ride suspensions, which contain air bags 400, 430, and optionally 450, respectively, using a hand-held air gauge.

According to another aspect, sensors 152 may be installed at locations near 470, 480, 490 to measure the air pressure in each of the isolated portions of the air-ride suspensions, thereby measuring or sensing the pressure associated with the air-ride suspension of the corresponding axles 330, 340, 350 of the vehicle 310 or the semi-trailer 320. To measure the pressure in the air suspension, it may be desired to place an additional airline and place the Schrader valve in a convenient location for measurement. Further, it may be desirable to determine the deviation of each pressure gauge, and calibrate all the air suspensions to monitor the load of each vehicle and trailer with air suspension using the system 100 for generating axle weight and load distribution value estimates.

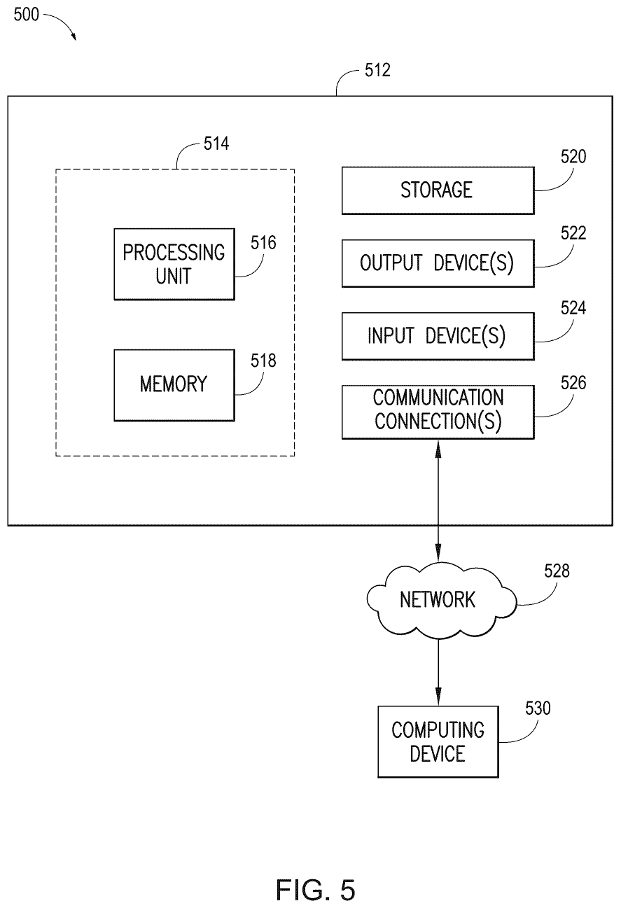

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, on-board truck computers, personal computers, server computers, hand-held or laptop devices, mobile devices, such as mobile phones, ELD's, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 700 including a computing device configured to implement one aspect provided herein. In one configuration, the computing device includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 5 by dashed line 714.

In other aspects, the computing device includes additional features or functionality. For example, the computing device may include additional storage such as removable storage or non-removable storage, including, but not limited to, magnetic storage, optical storage, etc. Such additional storage is illustrated in FIG. 5 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may store the desired information and which may be accessed by the computing device. Any such computer storage media is part of the computing device.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device includes input device(s) 724 such as keyboard, mouse, pen, voice input device, touch input device, infrared cameras, video input devices, or any other input device. Output device(s) 722 such as one or more displays, speakers, printers, or any other output device may be included with the computing device. Input device(s) 724 and output device(s) 722 may be connected to the computing device via a wired connection, wireless connection, or any combination thereof. In one aspect, an input device or an output device from another computing device may be used as input device(s) 724 or output device(s) 722 for the computing device. The computing device may include communication connection(s) 726 to facilitate communications with one or more other devices 730, such as through network 728, for example.

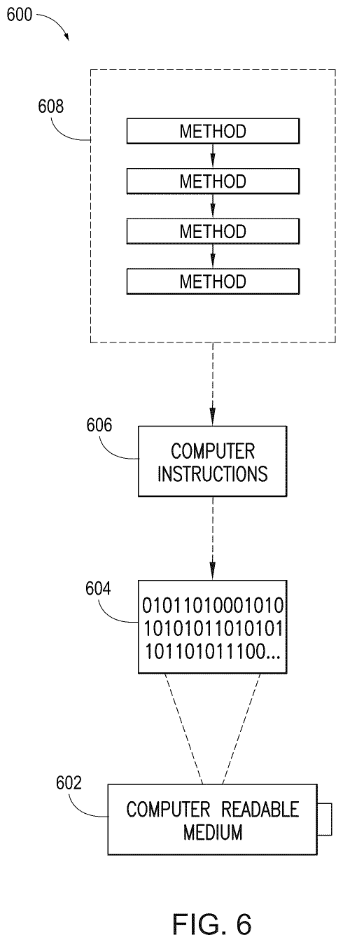

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 800 includes a computer-readable medium 802, such as a CD-R, DVD-R, flash drive, a platter of a hard disk drive, etc., on which is encoded computer-readable data 804. This encoded computer-readable data 804, such as binary data including a plurality of zero's and one's as shown in 804, in turn includes a set of processor-executable computer instructions 806 configured to operate according to one or more of the principles set forth herein. In this implementation 800, the processor-executable computer instructions 806 may perform a method 808, such as the method 200 for generating axle weight and load distribution value estimates of FIG. 2. In another aspect, the processor-executable computer instructions 806 may be configured to implement a system, such as the system 100 for generating axle weight and load distribution value estimates of FIG. 1. Many such computer-readable media may be devised by those of ordinary skill in the art that are configured to operate in accordance with the techniques presented herein.

In one embodiment, the system is configured to provide a simulated adjustment of moving the fifth wheel coupling by calculating, for each of the plurality of available positions, a predicted steering axle weight using the fifth wheel weight distribution coefficient for that position, filtering out positions that would result in the predicted steering axle weight exceeding a legal steering axle weight limit, and selecting a position from remaining positions that maximizes drive axle loading capacity without exceeding a legal drive axle weight limit. The simulated adjustment of adding fuel comprises calculating a drive axle weight reserve as a difference between a legal maximum drive axle weight and the current drive axle weight; calculating a maximum permissible fuel addition (r) according to

$$r = ( drive axle weight reserve ) / ( fuel weight per gallon \times K ( fuel ) ) , where$$

$$K ( fuel ) is the fuel weight distribution coefficient ,$$

calculating a predicted steering axle weight after adding the maximum permissible fuel addition according to

$$predicted steering axle weight = current steering axle weight ) + ( r \times fuel weight per gallon \times ( 1 - K ( fuel ) ) ) ,$$

determining whether the predicted steering axle weight exceeds a legal maximum steering axle weight, and including the maximum permissible fuel addition in the suggested action only when the predicted steering axle weight does not exceed the legal maximum steering axle weight.

In another embodiment, the processor is further configured to receive global positioning system (GPS) location data for the vehicle, receive route information indicating a planned travel path, access a database of jurisdiction-specific legal weight limits, determine, based on the GPS location data and the route information, legal weight limits applicable to multiple jurisdictions along the planned travel path, calculate predicted weight distributions for each jurisdiction, and generate jurisdiction-specific suggested actions to achieve compliance throughout the planned travel path.

In another embodiment, the processor is further configured to generate multimedia instructional content demonstrating how to perform the at least one identified simulated adjustment, wherein the multimedia instructional content comprises at least one of step-by-step video guidance showing physical adjustment procedures, animated diagrams illustrating weight distribution changes, or augmented reality overlays providing real-time guidance during adjustment, and transmit the multimedia instructional content to a mobile device for display to a user.

### Additional Methods and Computer-Implemented Programs

In one embodiment, the present invention provides a computer-implemented method for determining at least one physical cargo parameter of cargo loaded in a trailer of a vehicle, the vehicle comprising a tractor and the trailer coupled by a fifth wheel, the method comprising:
obtaining certified axle weight values of the vehicle from a certified weighing scale after loading of the trailer;
acquiring stored geometric parameters of the vehicle and trailer including axle spacing and fifth wheel position;
calculating, from the certified axle weight values and the stored geometric parameters, at least one physical cargo parameter including:
   cargo weight,
   longitudinal position of the cargo center of mass within the trailer, or
   available additional payload capacity of the vehicle within the trailer without repositioning the fifth wheel;
      wherein the determination of said at least one physical cargo parameter:
is performed without processing load measurement signals originating from a load sensor arranged at the fifth wheel coupling; and
does not require prior tare weighing of the vehicle before such loading.

In another embodiment, the present invention provides a computer-implemented method for determining at least one physical parameter of cargo loaded in a trailer of a vehicle, the vehicle comprising a tractor and the trailer coupled by a fifth wheel and provided with an air suspension system, the method comprising:
acquiring pressure values from air suspension elements of at least one drive axle of the tractor and at least one axle of the trailer after loading of the trailer;
converting the acquired pressure values into axle load values using a stored linear mathematical relationship between suspension pressure and axle load;
determining, based on the calculated axle load values and stored geometric parameters of the vehicle and trailer, at least one physical cargo parameter including:
   cargo weight,
   longitudinal position of the cargo center of mass, or
   available additional payload capacity of the tractor and the trailer without repositioning the fifth wheel;
      wherein the determination of said at least one physical cargo parameter:
is carried out without processing load measurement signals originating from a load sensor arranged at the fifth wheel coupling;
and does not require estimation or measurement of tare axle weights of the vehicle prior to loading.

In another embodiment, the present invention provides a computer-implemented method for determining a front axle load of a tractor of a vehicle, the method comprising:
acquiring fuel information representing at least one of:
   (i) a fuel volume in at least one fuel tank of the tractor, or
   (ii) a fuel weight in said at least one fuel tank;
acquiring stored vehicle geometry and mass distribution parameters including at least one of:
   a location of the at least one fuel tank relative to a front axle and a drive axle of the tractor, or a fuel-to-axle load transfer coefficient;
calculating, using an analytical model, a fuel-induced load contribution to the front axle based on the acquired fuel information and the stored vehicle geometry and mass distribution parameters; and
   determining the front axle load by combining the fuel-induced load contribution with at least one measured or estimated axle load component.

The fuel-induced load contribution is used to determine at least one physical parameter including a front axle load of the tractor or at least one physical cargo parameter in the trailer including cargo weight, longitudinal position of the cargo center of mass, or available additional payload capacity of the tractor and trailer without repositioning the fifth wheel, wherein the fuel-induced load contribution is determined by establishing a fuel-to-axle load transfer coefficient by at least one of:
determining a longitudinal length and position of one or more fuel tanks of the tractor relative to vehicle axles and using said parameters in a moment-arm calculation; or
determining said coefficient based on variation of axle load values before and after refueling of one or more fuel tanks.

In another embodiment, the present invention provides a computer-implemented method for determining a longitudinal position of a center of mass of cargo within a trailer coupled to a tractor via a fifth wheel, the method comprising:
positioning trailer tandems in a forward position;
using stored values representing a load of a front portion of an empty trailer borne by the fifth wheel and a load of a rear portion of the empty trailer borne by trailer tandem axles when the tandems are in the forward position;
determining a load on the fifth wheel and a load on the trailer tandem axles after loading of the trailer; and
   calculating the longitudinal position of the cargo center of mass based on a change in load and a distance between the fifth wheel and a group of the trailer tandem axles.

The axle loads are determined by weighing the vehicle on a certified weighing scale after loading of the trailer.

In another embodiment, the present invention provides a computer-implemented program executable on a smartphone or an onboard vehicle computer, configured to determine axle loads and/or cargo weight of a tractor-trailer vehicle combination comprising a tractor and a trailer, wherein the program:
receives data representing a weight of a driver and a passenger;
receives data representing a quantity of fuel in one or more fuel tanks;
receives data representing a quantity of diesel exhaust fluid (DEF);
receives data representing a load of drive axles of the tractor determined from suspension pressure values or measured axle weight values;
receives data representing a load of trailer axles determined from suspension pressure values or measured axle weight values; and
performs an analytical mass redistribution calculation based on geometric parameters of the vehicle to determine at least one load distribution parameter.

### Exemplary User Experience

Using the information described above, a user (typically a driver of a vehicle) can access a software program using any type of device (e.g., smartphone, tablet, ELD etc.). The software application may access information stored in a database that is specific to the vehicle and trailer (e.g., dimensions and locations of fuel and DEF tanks, fifth wheels, trailer axles etc.). Alternatively, the user can be prompted to enter the information. To aid in the acquisition of accurate information, the software application can provide graphic illustrations of what measurements should be taken and provide data entry points for the information being measured. Once the vehicle and trailer data is obtained, the software application can access the pressure data relating to the pressures within the isolated portions of the air ride systems for the vehicle and trailer. This information can be accessed by the software app via wireless communication from sensors on the vehicle and trailer. In addition, or alternatively, this pressure information can be entered manually by the user after measurements are taken at specified locations using hand-held devices. Once this information is entered into the software app, when a load is placed into the trailer, the user can use the software app to see how the weight values on the axles changes (ideally, sensors obtain pressure readings in the air ride suspension when the pressures settle out, and the software calculates the approximate weight values). As the user moves the fifth wheel and/or the trailer axle(s), additional pressure readings are taken and changes to the approximate weight values on the axles are displayed to the user via the software app. The user can continue to use the app to obtain additional information such as how much fuel to add, where to purchase the fuel, whether there is an opportunity to pick up an additional partial load yet remain under the legal weight requirements etc. The information is transmitted to the user's device (the vehicle and trailer need to be on a approximately horizontal/flat surface, and the air ride suspension pressures need a bit of time to settle out). In winter conditions, it may be advisable, where legally permissible and operationally appropriate, to moderately increase the load on the drive axles relative to the trailer tandems in order to improve road traction and reduce the risk of jackknife events.

### PREFERRED EMBODIMENTS

A preferred implementation is in the form of an onboard computer integrated into a commercial truck and connected to an expanded sensor network that continuously monitors key operational parameters. The system includes:
diesel fuel level sensors;
DEF level sensors;
load or air-pressure sensors of the drive axle suspension;
load or air-pressure sensors of the trailer suspension;
integration of data from certified vehicle scales (e.g., CAT scale or equivalent);
driver and passenger weight input or sensing mechanisms; and
additional operational parameters such as tandem position, fifth-wheel configuration, and other relevant load-distribution variables.

The onboard computer is configured to:
1. determine the weight of each axle;
2. calculate the total weight of the tractor, trailer, cargo, fuel, DEF, driver, and passenger;
3. analytically determine the longitudinal position of the cargo center of mass;
4. predict the optimal tandem position for proper load distribution;
5. display regulatory load limits and compliance status;
6. provide safety and fuel-efficiency recommendations; and
7. store operational data for analytics and fleet optimization.

The system may utilize:
an air-suspension-based weight determination method (via suspension pressure), and/or
certified scale measurements for calibration and high-accuracy reference data.

This solution transforms a commercial truck into a real-time digital weighing platform, reducing reliance on stationary scales and minimizing:
overload risk;
jackknife risk;
fuel inefficiency; and
excessive tire and suspension wear.

### Autonomous Trucking Implementations

As autonomous trucking technology advances, the system becomes fully automated:
autonomous trucks continuously monitor load balance;
automatically adjust operational parameters;
transmit data to centralized digital networks; and
optimize routing based on weight distribution and center-of-mass calculations.

Accordingly, the invention establishes a foundational digital infrastructure for the future of freight transportation, where load control is an integrated vehicle function rather than an external weighing procedure.

### SCOPE OF DISCLOSURE

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1: A system for generating axle weight estimates and load distribution recommendations for a vehicle with an air-ride suspension, the system comprising:
a memory configured to store vehicle configuration data and weight distribution coefficients; and
a processor configured to execute instructions to:
receive pressure data associated with an air-ride suspension of at least one of a drive axle of a vehicle or a trailer axle of a trailer coupled to the vehicle;
receive vehicle configuration information including at least: a base distance between a steering axle and the drive axle, a plurality of available positions for a fifth wheel coupling, fuel tank capacity information, and diesel exhaust fluid (DEF) tank capacity information;
retrieve, from the memory, stored weight distribution coefficients including: a fuel weight distribution coefficient representing a proportion of fuel weight distributed to the drive axle, a fifth wheel weight distribution coefficient for each of the plurality of available positions, and a DEF weight distribution coefficient;
calculate, based on the pressure data, the vehicle configuration information, and the stored weight distribution coefficients, current weight values for a plurality of axles including at least: a steering axle weight, a drive axle weight, and a trailer axle weight;
receive legal weight limit data corresponding to a route of the vehicle;
determine that at least one of the current weight values exceeds a corresponding legal weight limit or will exceed the corresponding legal weight limit after a planned change in vehicle status;
calculate a plurality of predicted weight distributions based on a plurality of simulated adjustments, each simulated adjustment selected from: moving the fifth wheel coupling from a current position to a different position of the plurality of available positions, moving trailer tandems to a different position, adding a specified amount of fuel to a fuel tank, or adding a specified amount of DEF to a DEF tank;
identify at least one simulated adjustment from the plurality of simulated adjustments that results in a predicted weight distribution satisfying the legal weight limit data; and
generate a suggested action comprising instructions to perform the at least one identified simulated adjustment.

2: The system according to claim 1, wherein the processor is further configured to calculate the plurality of predicted weight distributions by iteratively evaluating each possible combination of each of the plurality of available positions for the fifth wheel coupling, a plurality of trailer tandem positions, and a plurality of fuel addition amounts, wherein identifying the at least one simulated adjustment comprises selecting a combination that satisfies the legal weight limit data while maximizing at least one of: total load capacity, fuel efficiency, or weight distribution balance.

3: The system according to claim 1, wherein the simulated adjustment of moving trailer tandems comprises:
calculating a weight imbalance between the drive axle and the trailer axle;
calculating a required tandem movement distance according to
dM/inch=((M(drive)+M(trailer))/2−reference weight)×coefficient+constant weight per inch, where M(drive) is the drive axle weight, M(trailer) is the trailer axle weight, and the coefficient and constant weight per inch are empirically determined during calibration;
determining a number of holes to move the trailer tandems based on the required tandem movement distance and a known distance between adjacent holes; and
including the number of holes in the suggested action.

4: The system according to claim 1, wherein:
the pressure data is received wirelessly from a plurality of pressure sensors disposed within isolated portions of the air-ride suspension system;
the plurality of pressure sensors includes at least one or more drive axle pressure sensors connected to air-ride suspension components of the drive axle, and one or more trailer axle pressure sensors connected to air-ride suspension components of the trailer axle; and
the processor is configured to continuously receive updated pressure data and continuously update the current weight values in real-time.

5: The system according to claim 1, wherein the processor is further configured to:
determine that multiple different combinations of simulated adjustments result in predicted weight distributions satisfying the legal weight limit data;
rank the multiple different combinations based on at least one optimization criterion selected from minimizing total adjustment effort required, maximizing remaining load capacity after adjustment, optimizing weight distribution for vehicle stability and safety, minimizing impact on fuel consumption, or minimizing time required to perform adjustments;
select a highest-ranked combination; and
generate the suggested action comprising the highest-ranked combination.

6: The system according to claim 1, wherein the processor is further configured to:
receive trailer configuration data including:
(a) a distance between a kingpin of the fifth wheel coupling and a center position between axles of the trailer tandems in a front position,
(b) a distance between the kingpin and the center position between axles of the trailer tandems in a rear position, and
(c) a weight of the trailer tandems without a trailer box;
calculate a position of a center of mass of cargo loaded in the trailer according to:
$$L = ( M ( front ) \times A + M ( tandems ) \times B ) / ( M ( front ) + M ( rear ) )$$
where:
M(front) is a weight of a front part of the trailer bearing on the fifth wheel coupling;
M(rear) is a weight of a rear part of the trailer bearing on the trailer tandems;
M(tandems) is the weight of the trailer tandems without the trailer box;
A is the distance between the kingpin and the center position between axles of the trailer tandems; and
B is a distance between the kingpin and a center of mass of the trailer box without tandems; and
generate output data including a position of a center of mass of the trailer box loaded with cargo, excluding the trailer tandems, wherein the output data is usable to:
(i) determine optimal positioning of the trailer tandems for balanced weight distribution,
(ii) calculate available capacity for additional partial loads and their permissible placement positions within the trailer, or
(iii) facilitate associated transportation coordination by sharing cargo weight and center of mass information with potential carriers for less-than-truckload partial loads to reduce deadhead miles by distributing partial and/or full loads among vehicles.

7: A method for calibrating and operating a vehicle weight distribution system, the method comprising:
a calibration phase; and
an operational phase;
wherein the calibration phase comprises:
performing, by a processor, a first weighing operation with a vehicle having full fuel tanks and full diesel exhaust fluid (DEF) tanks with an empty trailer attached, the trailer tandems being in a front position;
receiving, by the processor, first weight measurements for a steering axle, a drive axle, and a trailer axle from the first weighing operation;
performing, by the processor, a second weighing operation with the vehicle having full fuel tanks and full DEF tanks with a loaded trailer attached;
receiving, by the processor, second weight measurements for the steering axle, the drive axle, and the trailer axle from the second weighing operation;
performing, by the processor, a third weighing operation with the vehicle without a trailer attached and having full fuel tanks and full DEF tanks;
receiving, by the processor, third weight measurements for the steering axle and the drive axle from the third weighing operation;
receiving, by the processor, dimension measurements of the vehicle including at least
a base distance between a center of the steering axle and a center of the drive axle,
a distance from the center of the steering axle to a center of gravity of a fuel tank,
a distance from the center of the steering axle to a center of gravity of a DEF tank,
a distance from the center of the steering axle to a fifth wheel position, and
a distance between adjacent fifth wheel positions;
calculating, by the processor and based on the first, second, and third weight measurements and the dimension measurements, a plurality of weight distribution coefficients including
a fuel weight distribution coefficient K(fuel)=a/base, where a is the distance from the center of the steering axle to the center of gravity of the fuel tank and base is the base distance,
a DEF weight distribution coefficient K(DEF)=b/base, where b is the distance from the center of the steering axle to the center of gravity of the DEF tank,
a fifth wheel weight distribution coefficient K(n) for a fifth wheel position n, where K(n)=p(n)/base and p(n) is the distance from the center of the steering axle to a fifth wheel pin in position n; and
storing, by the processor, the plurality of weight distribution coefficients in a memory; and
wherein the operational phase comprises:
receiving, by the processor, pressure data from an air-ride suspension system of the vehicle;
receiving, by the processor, current vehicle status information including: a current fuel level, a current DEF level, and a current fifth wheel position;
calculating, by the processor and based on the pressure data, the plurality of weight distribution coefficients, and the current vehicle status information, weight estimates for the steering axle, the drive axle, and the trailer axle; and
generating, by the processor, an output comprising the weight estimates.

8: The method according to claim 7, wherein calculating the plurality of weight distribution coefficients further comprises:
calculating a passenger weight distribution coefficient K(passengers) according to
K(passengers)=z/base, where z is a horizontal distance between the locations of the center of the steering axle and a center of gravity of a driver in a driver seat and passenger, if present; and
storing the passenger weight distribution coefficient in the memory.

9: The method according to claim 8, wherein calculating the fifth wheel weight distribution coefficient K(n) for the plurality of fifth wheel positions comprises:
measuring a distance p(0) from the center of the steering axle to a first fifth wheel position;
calculating K(0)=p(0)/base for the first fifth wheel position; and
calculating weight distribution coefficients for remaining positions using an arithmetic sequence formula: K(n)=K(0)+n×(d/base), where n is a position number and d is the distance between adjacent fifth wheel positions.

10: The method according to claim 7, further comprising:
establishing, by the processor, a linear relationship between pressure in the air-ride suspension system and axle weight, wherein establishing the linear relationship comprises
measuring pressure values in the air-ride suspension during the second and third weighing operations,
correlating the measured pressure values with corresponding weight measurements, and
determining linear coefficients relating pressure to weight for each axle; and
storing the linear coefficients in the memory for use in converting pressure data to weight estimates.

11: The method according to claim 7, wherein the weight estimates are calculated according to:
$$a steering axle weight ( M ( steering ) ) = M ( steering \cdot base ) + M ( front ) \times ( 1 - K ( n ) ) - dM ( passengers ) \times ( 1 - K ( passengers ) ) - dm ( fuel ) \times ( 1 - K ( fuel ) ) - dm ( DEF ) \times ( 1 - K ( DEF ) ) - M ( fifth ) \times ( n - k ) \times d / base ;$$
a drive axle weight (M(drive)) estimated from the pressure data using the linear relationship; and
a trailer axle weight (M(trailer)) estimated from the pressure data using the linear relationship;
where
M(front) is a weight bearing on a fifth wheel calculated from the drive axle weight and the weight distribution coefficients,
dM(passengers) is a difference in passenger weight from calibration, dm(fuel) is a difference in fuel weight from calibration,
dm(DEF) is a difference in DEF weight from calibration,
M(fifth) is a fifth wheel weight,
n is a current fifth wheel position,
k is a calibration fifth wheel position, and
d is a distance between adjacent fifth wheel positions.

12: The method according to claim 7, further comprising:
calculating, by the processor, a cargo weight (M(cargo)) according to: M(cargo)=M(gross)−M(bobtail)−M(empty·trailer), where: M(gross)=M(steering)+M(drive)+M(trailer), M(bobtail) is a current weight of the vehicle without the trailer calculated based on current fuel, DEF, and passenger weights, and M(empty·trailer) is an empty trailer weight stored during calibration; and
including the cargo weight in the output.

13: A non-transitory computer-readable medium having processor-executable instructions stored thereon that, when executed by a processor, cause the processor to implement a weight distribution coefficient system by:
storing, in a memory, calibration data comprising
(a) a plurality of weight distribution coefficients including
(1) a fuel weight distribution coefficient K(fuel) representing a proportion of fuel weight distributed to a drive axle,
(2) a plurality of fifth wheel weight distribution coefficients K(n) for a plurality of fifth wheel positions, wherein each coefficient K(n) is calculated according to K(n)=K(0)+n×(d/base), where K(0) is a coefficient for an initial position, n is a position number, d is a distance between adjacent fifth wheel positions, and base is a distance between a steering axle and the drive axle,
(3) a diesel exhaust fluid (DEF) weight distribution coefficient K(DEF), and
(4) a passenger weight distribution coefficient K(passengers);
(b) baseline weight values comprising
(1) a baseline steering axle weight M(steering·base),
(2) a baseline drive axle weight M(drive·base), and
(3) a baseline trailer weight M(empty·trailer);
receiving pressure data from sensors disposed within an air-ride suspension system;
converting the pressure data to estimated axle weights based on a linear relationship between pressure and weight, the linear relationship being specific to the vehicle and determined during calibration;
receiving current vehicle status information comprising
a current fuel weight,
a current DEF weight,
a current passenger weight, and
a current fifth wheel position number n;
calculating a weight bearing on a fifth wheel coupling (M(front)) according to
$$M ( front ) = ( M ( drive ) - ( M ( drive \cdot base ) - dM ( passengers ) \times K ( passengers ) - dm ( fuel ) \times K ( fuel ) - dm ( DEF ) \times K ( DEF ) + M ( fifth ) \times ( n - k ) \times d / base ) ) / K ( n ) ,$$
where
M(drive) is a current drive axle weight estimated from the pressure data,
dM(passengers) is a difference between the current passenger weight and a calibration passenger weight,
dm(fuel) is a difference between the current fuel weight and a calibration fuel weight,
dm(DEF) is a difference between the current DEF weight and a calibration DEF weight,
M(fifth) is a fifth wheel weight,
k is a calibration fifth wheel position number,
n is the current fifth wheel position number,
d is the distance between adjacent fifth wheel positions,
base is the distance between the steering axle and the drive axle, and
K(n) is the fifth wheel weight distribution coefficient for position n;
calculating a current steering axle weight (M(steering)) according to M(steering)=M(steering·base)+M(front)×(1−K(n))−dM(passengers)×(1−K(passengers))−dm(fuel)×(1−K(fuel))−dm(DEF)×(1−K(DEF))−M(fifth)×(n−k)×d/base;
calculating a gross weight of a vehicle and trailer assembly (M(gross)) according to M(gross)=M(steering)+M(drive)+M(trailer), where M(trailer) is a trailer axle weight estimated from the pressure data;
calculating a cargo weight (M(cargo)) according to M(cargo)=M(gross)−M(bobtail)−M(empty·trailer), where M(bobtail) is a current vehicle weight without the trailer; and
generating output data comprising at least the current steering axle weight, the current drive axle weight, M(trailer), M(front), and M(cargo).

14: The non-transitory computer-readable medium according to claim 13, wherein the processor-executable instructions further cause the processor to:
calculate a legal weight capacity of the vehicle and trailer without moving the fifth wheel and without adding fuel according to M(capacity)=((M(drive·max)−M(drive))/K(fifth))+(M(trailer·max)−M(trailer)), where
M(drive·max) is a maximum legal drive axle weight,
M(drive) is the current drive axle weight,
K(fifth) is a fifth wheel weight distribution coefficient for a current fifth wheel position,
M(trailer·max) is a maximum legal trailer axle weight, and
M(trailer) is a current trailer axle weight; and
include M(capacity) in the output data.

15: The non-transitory computer-readable medium according to claim 13, wherein the processor-executable instructions further cause the processor to:
receive an indication of a planned fuel addition;
calculate predicted weight values for the steering axle and the drive axle after the planned fuel addition according to predicted steering axle weight=M(steering)+(fuel addition amount)×(fuel weight per gallon)×(1−K(fuel)) and predicted drive axle weight=M(drive)+(fuel addition amount)×(fuel weight per gallon)×K(fuel);
determine whether the predicted weight values exceed legal weight limits;
when the predicted weight values exceed legal weight limits, calculate an alternative suggested action comprising at least one of moving the trailer tandems, moving the fifth wheel to a different position before adding fuel, or adding a reduced amount of fuel that maintains compliance with legal weight limits; and
generate a recommendation comprising the alternative suggested action.

16: The non-transitory computer-readable medium according to claim 13, wherein the processor-executable instructions further cause the processor to:
transmit the output data to a mobile device application via a wireless communication interface, wherein the mobile device application displays
(a) current weight values for each axle with visual indicators showing proximity to legal limits,
(b) the cargo weight,
(c) the weight bearing on the fifth wheel coupling,
(d) available load capacity, and
(e) interactive controls for simulating adjustments to vehicle configuration; and
receive user input from the mobile device application indicating a desired adjustment for simulation.

17: A distributed transportation network system comprising a central server and a plurality of vehicle computing devices, wherein:
each of the plurality of vehicle computing devices is associated with a vehicle having a processor configured to:
(i) receive pressure data from air-ride suspension sensors of the vehicle,
(ii) calculate current axle weights based on the pressure data and stored weight distribution coefficients,
(iii) determine a cargo weight and a position of a center of mass of the cargo,
(iv) calculate an available additional load capacity based on legal weight limits and current axle weights, and
(v) transmit vehicle capacity data including the cargo weight, the position of the center of mass, the available additional load capacity, and current GPS location to the central server via a wireless communication network; and
the central server is configured to:
(i) receive and store the vehicle capacity data from the plurality of vehicle computing devices in a database,
(ii) receive load requests including a requested cargo weight, requested cargo dimensions, a pickup location, and a delivery location,
(iii) identify compatible vehicles from the plurality of vehicles based on:
(a) whether the available additional load capacity exceeds the requested cargo weight,
(b) whether available spatial positioning in a trailer, calculated based on the position of the center of mass of existing cargo, accommodates the requested cargo dimensions,
(c) route compatibility between current vehicle location, destination, and the pickup and delivery locations, and
(d) predicted compliance with legal weight limits after adding the requested cargo at calculated optimal positioning,
(iv) rank the compatible vehicles based on at least one optimization criterion selected from minimizing deadhead miles, maximizing capacity utilization, minimizing total route deviation, or minimizing environmental impact, and
(v) transmit load matching notifications to mobile devices associated with drivers of the ranked compatible vehicles, the notifications including the requested cargo information and predicted impact on vehicle weight distribution.

18: The system according to claim 17, wherein the central server is further configured to:
identify backhaul opportunities by detecting vehicles traveling toward a home location or depot with available additional load capacity;
match return-leg loads with the identified vehicles based on route alignment between current location, load pickup location, load delivery location, and final destination;
calculate revenue per mile improvement for each potential backhaul load; and
prioritize backhaul load notifications to drivers based on maximizing revenue per mile while maintaining legal compliance with weight limits throughout the return journey.

19: The system according to claim 17, wherein the central server comprises a machine learning module configured to:
collect historical data from the plurality of vehicle computing devices, the historical data including:
(a) pressure-to-weight correlations for different vehicle and trailer configurations,
(b) actual versus predicted weight distributions after load additions,
(c) fuel efficiency impacts of different load configurations, and
(d) successful versus unsuccessful load matching outcomes;
train predictive models using the historical data to improve accuracy of:
(i) weight distribution coefficient calculations for different vehicle types,
(ii) available capacity predictions based on real-time conditions, and
(iii) optimal load matching recommendations;
distribute updated weight distribution coefficients and calibration parameters to the plurality of vehicle computing devices based on the trained models; and
continuously refine the predictive models as additional data is collected from the network.

20: A computer-implemented method for reducing deadhead miles in commercial trucking, the method comprising:
continuously receiving, at a central server, vehicle status data from a plurality of vehicles, each vehicle status data set comprising:
(a) current axle weights calculated from air-ride suspension pressure measurements,
(b) cargo weight and center of mass position,
(c) available additional load capacity calculated based on legal weight limits and current vehicle configuration,
(d) current GPS coordinates,
(e) planned route and destination, and
(f) trailer tandem position and fifth wheel position;
maintaining, in a database, a dynamic inventory of available capacity for each of the plurality of vehicles, the dynamic inventory being updated as vehicle status data changes;
receiving load requests from shippers or freight brokers, each load request specifying a cargo weight, cargo dimensions, pickup location, delivery location, and time constraints;
for each load request, executing a matching algorithm that:
(a) filters vehicles having available additional load capacity sufficient for the requested cargo weight,
(b) calculates, for each filtered vehicle, whether the requested cargo can be positioned within the trailer while maintaining legal weight distribution, using the stored cargo center of mass position and trailer configuration data,
(c) determines route deviation for each filtered vehicle by comparing the pickup and delivery locations to the vehicle's planned route,
(d) calculates a deadhead reduction metric representing miles saved by accepting the load versus traveling empty, and
(e) selects a subset of highest-ranked vehicles based on maximizing the deadhead reduction metric while satisfying time constraints;
transmitting load opportunity notifications to mobile devices of drivers of the selected vehicles, the notifications including:
(i) the load request details,
(ii) calculated optimal positioning for the cargo within the trailer,
(iii) predicted axle weights after loading, and
(iv) estimated deadhead miles saved;
receiving acceptance of the load opportunity from a driver's mobile device;
updating the dynamic inventory to reflect the reduced available capacity of the accepting vehicle; and
generating loading instructions for the driver, the instructions specifying optimal cargo placement based on the center of mass calculations and current trailer configuration.

21: A computer-implemented method for determining a longitudinal position of a center of mass of cargo loaded in a trailer coupled to a tractor via a fifth wheel kingpin, wherein trailer tandem axles are positioned in a forward position, the method comprising:
(1) obtaining, during a calibration condition with the trailer empty and the tandem axles positioned in the forward position
(a) a first front load value corresponding to a load borne by the fifth wheel, and
(b) a first tandem load value corresponding to a load borne by the trailer tandem axles;
(2) after loading cargo and with the tandem axles positioned in the forward position, obtaining
(a) a second front load value corresponding to a load borne by the fifth wheel, and
(2) a second tandem load value corresponding to a load borne by the trailer tandem axles;
(3) determining a front load increment according to the formula
$$Δ M ( tandems ) = ( second tandem load value ) - ( first tandem load value ) ;$$
(4) determining a tandem load increment according to the formula
$$M ( cargo ) = Δ M ( front ) + Δ M ( tandems ) ;$$
(4) determining a total cargo weight according to the formula
$$Δ M ( front ) = ( second front load value ) - ( first front load value ) ;$$
(5) retrieving a known geometric distance A between the kingpin and a center position between the tandem axles in the forward position; and
(6) calculating a longitudinal cargo center-of-mass position x relative to the kingpin according to the formula
$$x = A \times Δ M ( tandems ) / ( Δ M ( front ) + Δ M ( tandems ) ) ,$$
wherein x represents a longitudinal position of the cargo center of mass along a trailer length measured from the kingpin toward the tandem axles.
